(19) United States
(12) Patent Application Publication
(10) Pub. No.: US 2026/0230288 A1
(43) Pub. Date: Aug. 6, 2026

(54) INDICATION OF PREDICTED TRANSMISSION CONFIGURATION INDICATOR STATES

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US)

(21) Appl. No.: 19/152,736

(22) PCT Filed: Mar. 31, 2023
(86) PCT No.: PCT/CN2023/085329

§ 371 Date: Jul. 31, 2025

(51) Int. Cl. H04L 5/00

(52) U.S. Cl. CPC H04L 5/0094

(57) ABSTRACT

Methods, systems, and devices for wireless communications are described. A user equipment (UE) may receive a first control signal indicating a first transmission configuration indicator (TCI) state for a first time domain window and a second TCI state for a second time domain window that is subsequent to the first time domain window, the second TCI state comprising a predicted TCI state. The UE may receive a second control signal triggering activation of the first TCI state for communications during the first time domain window based at least in part on the first control signal. The UE may switch, according to the second control signal, to the second TCI state for communications during the second time domain window based at least in part on the first control signal and an expiration of the first time domain window.

### CROSS REFERENCE

The present Application is a 371 national phase filing of International PCT Application No. PCT/CN2023/085329 by LI et al., entitled “INDICATION OF PREDICTED TRANSMISSION CONFIGURATION INDICATOR STATES,” filed Mar. 31, 2023, which is assigned to the assignee hereof, and which is expressly incorporated by reference in its entirety herein.

### FIELD OF TECHNOLOGY

The following relates to wireless communications, including indication of predicted transmission configuration indicator states.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indication of predicted transmission configuration indicator (TCI) states. For example, the described techniques provide for a network entity that may transmit a first control signal (e.g., a medium access control-control element (MAC-CE) TCI activation signal) to a user equipment (UE) that indicates or otherwise identifies multiple TCI states to be used for communications with the UE. The multiple TCI states may include at least a first TCI state that is to be used for communications with the UE, with the first TCI state being associated with a corresponding first time domain window during which the UE is to use or otherwise apply the first TCI state. The multiple TCI states may also include one or more additional TCI states (e.g., second TCI state(s)) that are each predicted TCI states for corresponding second time domain window(s). The network entity may transmit a second control signal (e.g., a downlink control information (DCI) TCI switch signal) to the UE triggering activation of the first TCI state. The UE may use or otherwise apply the first TCI state during the first time domain window and, upon expiration of the first time domain window, switch to the second TCI state (e.g., the predicted TCI state) for communications during the second time domain window. The UE may continue to switch to additional predicted TCI states during corresponding time domain windows.

A method for wireless communications at a UE is described. The method may include receiving a first control signal indicating a first TCI state for a first time domain window and a second TCI state for a second time domain window that is subsequent to the first time domain window, the second TCI state including a predicted TCI state, receiving a second control signal triggering activation of the first TCI state for communications during the first time domain window based on the first control signal, and switching, according to the second control signal, to the second TCI state for communications during the second time domain window based on the first control signal and an expiration of the first time domain window.

An apparatus for wireless communications at a UE is described. The apparatus may include a processor, memory coupled with the processor, and instructions stored in the memory. The instructions may be executable by the processor to cause the apparatus to receive a first control signal indicating a first TCI state for a first time domain window and a second TCI state for a second time domain window that is subsequent to the first time domain window, the second TCI state including a predicted TCI state, receive a second control signal triggering activation of the first TCI state for communications during the first time domain window based on the first control signal, and switching, accord to the second control signal, to the second TCI state for communications during the second time domain window based on the first control signal and an expiration of the first time domain window.

Another apparatus for wireless communications at a UE is described. The apparatus may include means for receiving a first control signal indicating a first TCI state for a first time domain window and a second TCI state for a second time domain window that is subsequent to the first time domain window, the second TCI state including a predicted TCI state, means for receiving a second control signal triggering activation of the first TCI state for communications during the first time domain window based on the first control signal, and means for switching, according to the second control signal, to the second TCI state for communications during the second time domain window based on the first control signal and an expiration of the first time domain window.

A non-transitory computer-readable medium storing code for wireless communications at a UE is described. The code may include instructions executable by a processor to receive a first control signal indicating a first TCI state for a first time domain window and a second TCI state for a second time domain window that is subsequent to the first time domain window, the second TCI state including a predicted TCI state, receive a second control signal triggering activation of the first TCI state for communications during the first time domain window based on the first control signal, and switching, accord to the second control signal, to the second TCI state for communications during the second time domain window based on the first control signal and an expiration of the first time domain window.

In some examples of the method, apparatuses, and non-transitory computer-readable medium described herein, receiving the first control signal may include operations, features, means, or instructions for receiving an indication of a time offset between a first ending time of the first time domain window and a second ending time of the second time domain window, where the expiration of the first time domain window may be based on the time offset.

In some examples of the method, apparatuses, and non-transitory computer-readable medium described herein, receiving the first control signal may include operations, features, means, or instructions for receiving a radio resource control (RRC) signal that semi-statically defines the time offset between the first time domain window and the second time domain window.

In some examples of the method, apparatuses, and non-transitory computer-readable medium described herein, receiving the first control signal may include operations, features, means, or instructions for receiving DCI that dynamically defines the time offset between the first time domain window and the second time domain window.

In some examples of the method, apparatuses, and non-transitory computer-readable medium described herein, receiving the first control signal may include operations, features, means, or instructions for receiving an indication of a set of multiple second time domain windows, wherein the second time domain window is one of the set of second time domain windows, where each time domain window in the set of multiple second time domain windows is associated with a respective predicted TCI state, where a sequentially last time domain window of the set of multiple second time domain windows may be associated with an undefined ending point.

In some examples of the method, apparatuses, and non-transitory computer-readable medium described herein, a duration of the second time domain window may be based on a duration of the first time domain window in accordance with a defined ratio.

In some examples of the method, apparatuses, and non-transitory computer-readable medium described herein, the first time domain window and the second time domain window may be equal in duration.

In some examples of the method, apparatuses, and non-transitory computer-readable medium described herein, the first time domain window and the second time domain window may be unequal in duration.

Some examples of the method, apparatuses, and non-transitory computer-readable medium described herein may further include operations, features, means, or instructions for receiving, via the first control signal, one or more TCI state codepoints, each TCI state codepoint identifying a set of predicted TCI states during a corresponding set of second time domain windows, the set of predicted TCI states based on the second TCI state and receiving, via the second control signal, a TCI state codepoint from the one or more TCI state codepoints, where switching to the second TCI state may be based on receiving the TCI state codepoint.

Some examples of the method, apparatuses, and non-transitory computer-readable medium described herein may further include operations, features, means, or instructions for receiving, via the first control signal, for each TCI state codepoint in the one or more TCI state codepoints, an indication of a number of predicted TCI states for the TCI state codepoint.

In some examples of the method, apparatuses, and non-transitory computer-readable medium described herein, each TCI state codepoint in the one or more TCI state codepoints includes a common number of predicted TCI states.

Some examples of the method, apparatuses, and non-transitory computer-readable medium described herein may further include operations, features, means, or instructions for receiving, via the second control signal, for each TCI state codepoint in the one or more TCI state codepoints, an indication of a duration of a time domain window for each predicted TCI state in the set of predicted TCI states, where the second time domain window may be based on the duration.

In some examples of the method, apparatuses, and non-transitory computer-readable medium described herein, the second time domain window includes the equal duration.

Some examples of the method, apparatuses, and non-transitory computer-readable medium described herein may further include operations, features, means, or instructions for receiving the first control signal via a group common MAC-CE, where the UE belongs to a group of UEs associated with the group common MAC-CE.

Some examples of the method, apparatuses, and non-transitory computer-readable medium described herein may further include operations, features, means, or instructions for receiving the second control signal via a group common DCI, where the UE belongs to a group of UEs associated with the group common DCI.

In some examples of the method, apparatuses, and non-transitory computer-readable medium described herein, the first control signal indicates that the UE belongs to the group of UEs.

Some examples of the method, apparatuses, and non-transitory computer-readable medium described herein may further include operations, features, means, or instructions for receiving the second control signal via a UE-specific DCI.

Some examples of the method, apparatuses, and non-transitory computer-readable medium described herein may further include operations, features, means, or instructions for receiving, prior to the second time domain window, a third control signal triggering activation of an updated TCI state during the second time domain window and overriding switching to the second TCI state and switching to the updated TCI state during the second time domain window based on the third control signal.

A method for wireless communications at a network entity is described. The method may include transmitting, to a UE, a first control signal indicating a first TCI state for a first time domain window and a second TCI state for a second time domain window that is subsequent to the first time domain window, the second TCI state including a predicted TCI state, transmitting a second control signal to the UE triggering activation of the first TCI state for communications during the first time domain window based on the first control signal, and communicating with the UE, according to the second control signal, using the second TCI state during the second time domain window based on the first control signal and an expiration of the first time domain window.

An apparatus for wireless communications at a network entity is described. The apparatus may include a processor, memory coupled with the processor, and instructions stored in the memory. The instructions may be executable by the processor to cause the apparatus to transmit, to a UE, a first control signal indicating a first TCI state for a first time domain window and a second TCI state for a second time domain window that is subsequent to the first time domain window, the second TCI state including a predicted TCI state, transmit a second control signal to the UE triggering activation of the first TCI state for communications during the first time domain window based on the first control signal, and communicate with the UE, according to the second control signal, using the second TCI state during the second time domain window based on the first control signal and an expiration of the first time domain window.

Another apparatus for wireless communications at a network entity is described. The apparatus may include means for transmitting, to a UE, a first control signal indicating a first TCI state for a first time domain window and a second TCI state for a second time domain window that is subsequent to the first time domain window, the second TCI state including a predicted TCI state, means for transmitting a second control signal to the UE triggering activation of the first TCI state for communications during the first time domain window based on the first control signal, and means for communicating with the UE, according to the second control signal, using the second TCI state during the second time domain window based on the first control signal and an expiration of the first time domain window.

A non-transitory computer-readable medium storing code for wireless communications at a network entity is described. The code may include instructions executable by a processor to transmit, to a UE, a first control signal indicating a first TCI state for a first time domain window and a second TCI state for a second time domain window that is subsequent to the first time domain window, the second TCI state including a predicted TCI state, transmit a second control signal to the UE triggering activation of the first TCI state for communications during the first time domain window based on the first control signal, and communicate with the UE, according to the second control signal, using the second TCI state during the second time domain window based on the first control signal and an expiration of the first time domain window.

In some examples of the method, apparatuses, and non-transitory computer-readable medium described herein, transmitting the first control signal may include operations, features, means, or instructions for transmitting an indication of a time offset between a first ending time of the first time domain window and a second ending time of the second time domain window, where the expiration of the first time domain window may be based on the time offset.

In some examples of the method, apparatuses, and non-transitory computer-readable medium described herein, transmitting the first control signal may include operations, features, means, or instructions for transmitting an RRC signal that semi-statically defines the time offset between the first time domain window and the second time domain window.

In some examples of the method, apparatuses, and non-transitory computer-readable medium described herein, transmitting the first control signal may include operations, features, means, or instructions for transmitting DCI that dynamically defines the time offset between the first time domain window and the second time domain window.

In some examples of the method, apparatuses, and non-transitory computer-readable medium described herein, transmitting the first control signal may include operations, features, means, or instructions for transmitting an indication of a set of multiple second time domain windows, wherein the second time domain window is one of the set of multiple second time domain windows, where each time domain window in the set of multiple second time domain windows is associated with a respective predicted TCI state, where a sequentially last time domain window of the set of multiple second time domain windows may be associated with an undefined ending point.

In some examples of the method, apparatuses, and non-transitory computer-readable medium described herein, a duration of the second time domain window may be based on a duration of the first time domain window in accordance with a defined ratio.

In some examples of the method, apparatuses, and non-transitory computer-readable medium described herein, the first time domain window and the second time domain window may be equal in duration.

In some examples of the method, apparatuses, and non-transitory computer-readable medium described herein, the first time domain window and the second time domain window may be unequal in duration.

Some examples of the method, apparatuses, and non-transitory computer-readable medium described herein may further include operations, features, means, or instructions for transmitting, via the first control signal, one or more TCI state codepoints, each TCI state codepoint identifying a set of predicted TCI states during a corresponding set of second time domain windows, the set of predicted TCI states based on the second TCI state and transmitting, via the second control signal, a TCI state codepoint from the one or more TCI state codepoints, where communicating with the UE using the second TCI state may be based on transmitting the TCI state codepoint.

Some examples of the method, apparatuses, and non-transitory computer-readable medium described herein may further include operations, features, means, or instructions for transmitting, via the first control signal, for each TCI state codepoint in the one or more TCI state codepoints, an indication of a number of predicted TCI states for the TCI state codepoint.

In some examples of the method, apparatuses, and non-transitory computer-readable medium described herein, each TCI state codepoint in the one or more TCI state codepoints includes a common number of predicted TCI states.

Some examples of the method, apparatuses, and non-transitory computer-readable medium described herein may further include operations, features, means, or instructions for transmitting, via the second control signal, for each TCI state codepoint in the one or more TCI state codepoints, an indication of a duration of a time domain window for each predicted TCI state in the set of predicted TCI states, where the second time domain window may be based on the duration.

In some examples of the method, apparatuses, and non-transitory computer-readable medium described herein, the second time domain window includes the equal duration.

Some examples of the method, apparatuses, and non-transitory computer-readable medium described herein may further include operations, features, means, or instructions for transmitting the first control signal via a group common MAC-CE, where the UE belongs to a group of UEs associated with the group common MAC-CE.

Some examples of the method, apparatuses, and non-transitory computer-readable medium described herein may further include operations, features, means, or instructions for transmitting the second control signal via a group common DCI, where the UE belongs to a group of UEs associated with the group common DCI.

In some examples of the method, apparatuses, and non-transitory computer-readable medium described herein, the first control signal indicates that the UE belongs to the group of UEs.

Some examples of the method, apparatuses, and non-transitory computer-readable medium described herein may further include operations, features, means, or instructions for transmitting the second control signal via a UE-specific DCI.

Some examples of the method, apparatuses, and non-transitory computer-readable medium described herein may further include operations, features, means, or instructions for transmitting, prior to the second time domain window, a third control signal triggering activation of an updated TCI state during the second time domain window and overriding a switch to the second TCI state and switching to the updated TCI state during the second time domain window based on the third control signal.

### BRIEF DESCRIPTION OF THE DRAWINGS

FIG. 1 shows an example of a wireless communications system that supports indication of predicted transmission configuration indicator states in accordance with one or more aspects of the present disclosure.

FIG. 2 shows an example of a wireless communications system that supports indication of predicted transmission configuration indicator states in accordance with one or more aspects of the present disclosure.

FIG. 3 shows an example of a TCI scheme that supports indication of predicted transmission configuration indicator states in accordance with one or more aspects of the present disclosure.

FIGS. 4A and 4B show examples of a TCI scheme that supports indication of predicted transmission configuration indicator states in accordance with one or more aspects of the present disclosure.

FIGS. 5A and 5B show examples of a TCI scheme that supports indication of predicted transmission configuration indicator states in accordance with one or more aspects of the present disclosure.

FIG. 6 shows an example of a TCI scheme that supports indication of predicted transmission configuration indicator states in accordance with one or more aspects of the present disclosure.

FIG. 7 shows an example of a TCI scheme that supports indication of predicted transmission configuration indicator states in accordance with one or more aspects of the present disclosure.

FIGS. 8 and 9 show block diagrams of devices that support indication of predicted transmission configuration indicator states in accordance with one or more aspects of the present disclosure.

FIG. 10 shows a block diagram of a communications manager that supports indication of predicted transmission configuration indicator states in accordance with one or more aspects of the present disclosure.

FIG. 11 shows a diagram of a system including a device that supports indication of predicted transmission configuration indicator states in accordance with one or more aspects of the present disclosure.

FIGS. 12 and 13 show block diagrams of devices that support indication of predicted transmission configuration indicator states in accordance with one or more aspects of the present disclosure.

FIG. 14 shows a block diagram of a communications manager that supports indication of predicted transmission configuration indicator states in accordance with one or more aspects of the present disclosure.

FIG. 15 shows a diagram of a system including a device that supports indication of predicted transmission configuration indicator states in accordance with one or more aspects of the present disclosure.

FIGS. 16 through 20 show flowcharts illustrating methods that support indication of predicted transmission configuration indicator states in accordance with one or more aspects of the present disclosure.

### DETAILED DESCRIPTION

Wireless networks may use control signaling to configure various parameters for user equipment (UE). For example, a network entity may transmit control signaling that identifiers configuration parameters to be used for communications with the UE (e.g., uplink communications and downlink communications). The UE and network entity perform the communications according to the control signaling. This may include separate control signaling being used to configure each UE, which includes both initial configuration as well as configuration updates when needed. Such resource intensive control signaling approaches consume extensive over-the-air resources as well as processing power and power consumption at the UE.

Accordingly, aspects of the described techniques relate to improved methods, systems, devices, and apparatuses that support indication of predicted transmission configuration indicator (TCI) states. For example, the described techniques provide for a network entity that may transmit a first control signal (e.g., a medium access control-control element (MAC-CE) TCI activation signal) to a UE that indicates or otherwise identifies multiple TCI states) to be used for communications with the UE. The multiple TCI states may include at least a first TCI state that is to be used for communications with the UE, with the first TCI state being associated with a corresponding first time domain window during which the UE is to use or otherwise apply the first TCI state. The multiple TCI states may also include one or more additional TCI states (e.g., second TCI state(s)) that are each predicted TCI states for corresponding second time domain window(s). The network entity may transmit a second control signal (e.g., a downlink control information (DCI) TCI switch signal) to the UE triggering activation of the first TCI state. The UE may use or otherwise apply the first TCI state during the first time domain window and, upon expiration of the first time domain window, switch to the second TCI state (e.g., the predicted TCI state) for communications during the second time domain window. The UE may continue to switch to additional predicted TCI states during corresponding time domain windows.

Aspects of the disclosure are initially described in the context of wireless communications systems. Aspects of the disclosure are further illustrated by and described with reference to apparatus diagrams, system diagrams, and flowcharts that relate to indication of predicted transmission configuration indicator states.

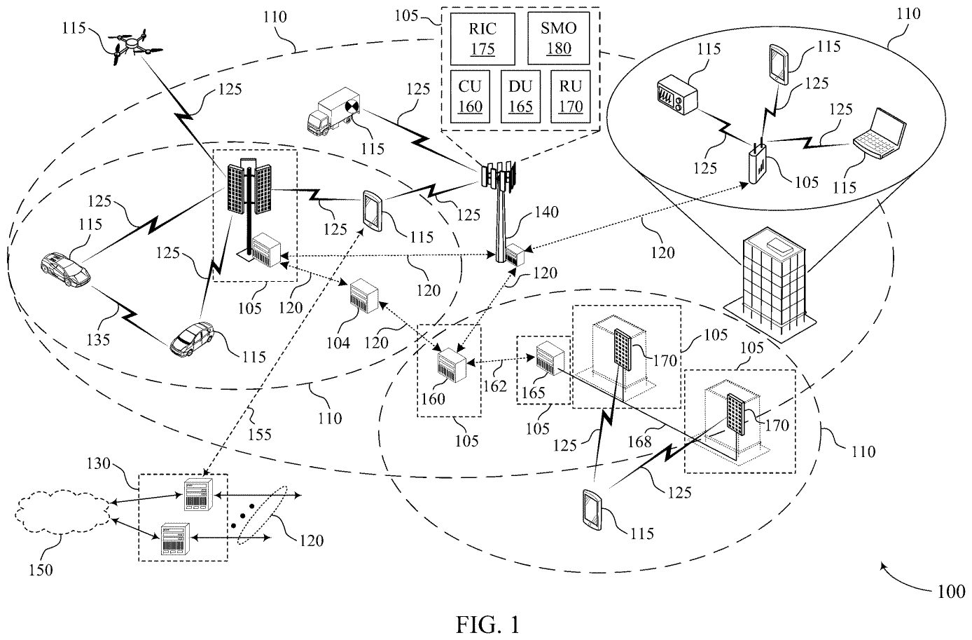

FIG. 1 shows an example of a wireless communications system 100 that supports indication of predicted transmission configuration indicator states in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support indication of predicted transmission configuration indicator states as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which (Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a first control signal indicating a first TCI state for a first time domain window and a second TCI state for a second time domain window that is subsequent to the first time domain window, the second TCI state comprising a predicted TCI state. The UE 115 may receive a second control signal triggering activation of the first TCI state for communications during the first time domain window based at least in part on the first control signal. The UE 115 may switch, according to the second control signal, to the second TCI state for communications during the second time domain window based at least in part on the first control signal and an expiration of the first time domain window.

A network entity 105 may transmit, to a UE 115, a first control signal indicating a first TCI state for a first time domain window and a second TCI state for a second time domain window that is subsequent to the first time domain window, the second TCI state comprising a predicted TCI state. The network entity 105 may transmit a second control signal to the UE 115 triggering activation of the first TCI state for communications during the first time domain window based at least in part on the first control signal. The network entity 105 may communicate with the UE 115, according to the second control signal, using the second TCI state during the second time domain window based at least in part on the first control signal and an expiration of the first time domain window.

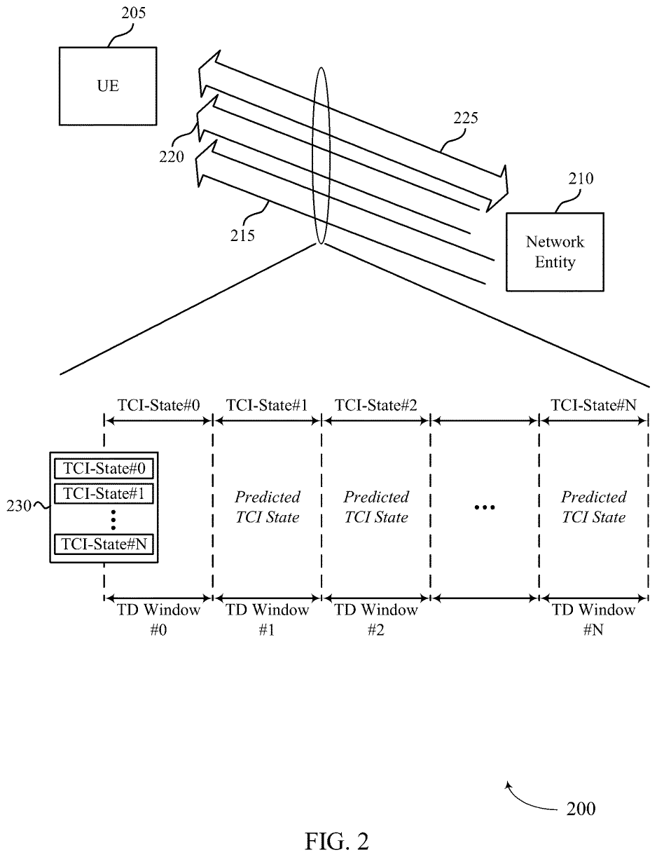

FIG. 2 shows an example of a wireless communications system 200 that supports indication of predicted TCI states in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Wireless networks use control signaling to signal or otherwise identify various parameters to be used for wireless communications between the network and UE. For example, the network entity 210 may transmit control signaling that identifies configuration parameters dynamically and/or persistently. For example, dynamic control signaling may include MAC-CE signaling and/or DCI signaling. Examples of more persistent signaling (e.g., semi-persistent and/or persistent) may include RRC signaling and/or other higher layer signaling. Control signaling generally uses over-the-air resources as well as processing power and energy consumption by the transmitting and receiving wireless devices.

One example of such parameters includes the network configuring TCI states for a UE. The TCI state generally defines the QCL relation between signals (e.g., the QCL Type relationship between reference signal(s), physical downlink control or shared channel (PDxCH), sounding reference signal (SRS), and/or physical uplink control or shared channel (PUxCH) signals). The network may generally identify available TCI states for the UE via RRC signaling, and then use a MAC-CE TCI activation signal to activate one or two particular TCI states for the UE. The network may then dynamically indicate a DCI TCI switch signal to the UE that “turns on” an activated TCI state to be used for communications. The network generally selects TCI states for activation and switching based on communications being performed with the UE. That is, the network identifies beams to be used for uplink and/or downlink communications with the UE and then activates/switches on based on the relationship between the identified beams/signals.

In some aspects, this may result in inefficient resource usage as well as unnecessary processing and power consumption by the wireless devices. As one non-limiting example, UE may be traveling or otherwise traversing an expected path. As the UE travels along the path, directional beams being used for communications with the UE may regularly change (e.g., due to UE movement). As different beams are used for communications with the UE at different points along the path, this triggers activation and switching to multiple TCI states for the UE. In some examples, multiple UE may be traveling along the same expected path (e.g., along a highway, on a train, on a waterway, etc.). This situation may trigger significant control signaling between the network and each UE as separate control signaling is used to activate and switch the TCI states for each UE at different points along the path. When the multiple UE are traveling along the expected path at a high mobility rate, such multitude and frequent updates become untenable in terms of resource usage, processing power, and energy consumption.

Accordingly, aspects of the techniques described herein provide various mechanisms that improve control signaling efficiency, for example to leveraging predictions to activate and switch TCI states for a UE, such as a UE traveling along a known or expected path or route. The network may learn or otherwise identify certain patterns or historical usages for the UE over time, such as using machine learning (ML), artificial intelligence (AI), or other learning or data-driven methods and techniques. One non-limiting example may include the network (e.g., the network entity 210) identifying a set of predicted TCI states (each of which may be referred to as a second TCI state) for the UE for a corresponding set of time domain windows. The network may identify a confidence level for the predicted TCI states base on such learning models and use enable use of the predicted TCI states during the corresponding time domain windows, e.g., when the confidence level for the predicted TCI state(s) satisfies a confidence threshold. Instead of indicating a single instantaneous TCI-state, the network entity 210 may alternatively signal a sequence of TCI-states predicted via AI/ML regarding a number of future time domain occasions. In some examples, such indication may be based on UE-group common signaling such that the overhead for indicating TCI-state switch can be further reduced.

At 215, the network entity 210 may transmit or otherwise provide (and the UE 205 may receive or otherwise obtain) a first control signal that carries or otherwise conveys an indication of a first TCI state (TCI-State #0) for a first time domain window (e.g., TD Window #0), such as via TCI state indication 230. The first control signal may further indicate a second TCI state (e.g., a predicted TCI state, TCI-State #1) for a second time domain window (TD Window #1) that is subsequent to the first time domain window. That is, the second time domain window may begin at the end of the first time domain window with or without a gap period between the time domain windows. In some examples, the first control signal may be a MAC-CE control signal conveying TCI state indication 230. The MAC-CE control signal may be a TCI state activation signal activating at TCI state(s) that may have been previously RRC (pre)configured for the UE 205. The first control signal may be a UE-specific MAC-CE or may be a group common MAC-CE (e.g., the UE 205 may belong to the group of UEs associated with the group common MAC-CE).

At 220, the network entity 210 may transmit or otherwise provide (and the UE 205 may receive or otherwise obtain) a second control signal that triggers activation of the first TCI state for communications during the first time domain window. The second control signal may identify the first TCI state for the UE 205 to switch to for communications during the first time domain window. In some examples, the second control signal may be a DCI control signal conveying a TCI switch command (e.g., a DCI format 1_1 or other DCI format). That is, the second control signal may indicate or otherwise identify the first TCI state previously activated for the UE 205 to be switched to for communications during the first time domain window, e.g., due to signal(s), beam(s), and the like, being used for communications during the first time domain window. The UE 205 may switch or otherwise transition to the first TCI state for communications at 225 during the first time domain window. The communications using the first TCI state during the first time domain window may include, but are not limited, for PDxCH communications received during the first time domain window and/or for SRs/PUxCH communications transmitted during the first time domain window.

In the non-limiting example illustrated in FIG. 2, the TCI state indication 230 identifies the first TCI state and 1-N predicted TCI states during the corresponding 1-N subsequent time domain windows, with N being a positive integer. In some aspects, N may refer to the number of second TCI states (e.g., predicted TCI states) with corresponding second time domain windows indicated for the UE 205. That is, the second TCI state in the non-limiting example illustrated in FIG. 2 may include N second TCI states (e.g., TCI-State #1, TCI-State #2, . . . TCI-State #N) during corresponding second time domain windows (e.g., TD Window #1, TD Window #2, . . . , TD Window #N). The first and second time domain window(s) may be subsequent to each other (e.g., the next time domain window may begin when the current time domain window expires). For example, the second control signal triggering activation of the first TCI state during the first time domain window may serve to trigger the UE to switch to the second TCI state upon expiration of the first time domain window. That is, the UE 205 may switch to TCI-State #1 upon expiration of the TD Window #0. The UE 205 may communicate with the network entity 210 during the TD Window #1. Upon expiration of the TD Window #1, the UE 205 may switch to the TCI-State #2 for communications during the TD Window #2. The UE 205 may continue to switch to the predicted TCI states during their corresponding TD windows for N. This use of predicted TCI states may enable the network to switch the TCI states of the UE 205 for a plurality of time domain windows (e.g., second time domain windows for predicted TCI states) without requiring additional control signaling used to activate and/or switch the TCI state of the UE 205. The UE 205 may apply the QCL relationship associated with the TCI states during their respective time domain windows for the communications with the network entity 210.

Accordingly, the network entity 210 may transmit or otherwise provide (and the UE 205 may receive or otherwise obtain) an indication of a plurality of second time domain windows which include the second time domain window (e.g., the N second time domain windows). In some examples, the duration of the first time domain window and the second time domain window may be equal or different. In some examples, the duration of the second time domain window may be based on the duration of the first time domain window, e.g., based on a ratio or other weighting factor applied to the first time domain window to determine the second time domain window. In some examples, the last time domain window in the second time domain windows (e.g., TD Window #N) may have an undefined ending point.

Accordingly, wireless communications system 200 illustrates a non-limiting example where the network entity 210 indicates predicted TCI-States for multiple future TD Windows. The UE 205 receives the network entity 210 signaled TCI-state switch indications, wherein the indication message carries or otherwise conveys an indication of multiple TCI-states respectively applied to multiple future time domain windows. The starting point of the first time domain window may follow conventional TCI-state switching times. The last time domain window (e.g., TD Window #N) may comprise no ending point. The UE 205 may apply the QCL information comprised by the TCI-state associated with a certain future time domain window, such as for PDxCH received during such time domain window and/or for SRS/PUxCH transmitted during such time domain window.

In some aspects, the first and/or second control signaling may be based on a UE group common indication, where the UE 205 belongs to or is otherwise associated with the group of UEs. Such UE-group common signaling may be based on signaling corresponding to multiple UEs. The group common signaling may carry or otherwise indicate the same set of such multiple TCI-states (e.g., predicted TCI states) associated with respective future time domain windows. The UEs within the group may all apply the QCL information comprised by or otherwise associated with the TCI-state associated with a certain future time domain window, such as for PDxCH received during such time domain windows and/or for SRS/PUxCH transmitted during such time domain window.

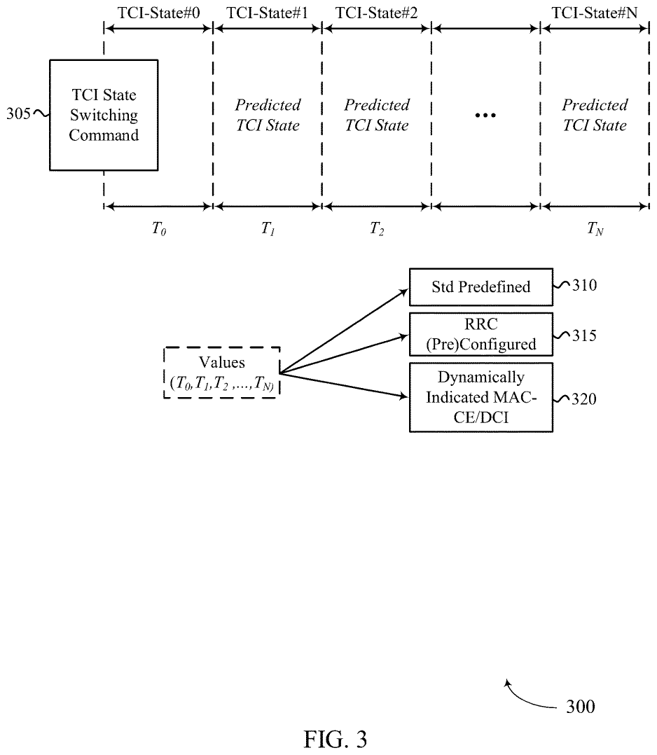

FIG. 3 shows an example of a TCI scheme 300 that supports indication of predicted TCI states in accordance with one or more aspects of the present disclosure. Aspects of TCI scheme 300 may implement or be implemented by aspects of wireless communications system 100 and/or wireless communications system 200. Aspects of TCI scheme 300 may be implemented at or implemented by a UE and/or network entity, which may be examples of the corresponding devices described herein.

As discussed above, the techniques described herein provide for the network signaling multiple predicted TCI states to be applied by the UE during corresponding time domain windows, with each predicted TCI state referring to second TCI state(s) and the corresponding time domain windows referring to second time domain window(s). The network entity may transmit to the UE a first control signal (e.g., a MAC-CE TCI activation signal) that identifies a first TCI state and the second TCI state(s). The first TCI state may be applied during a corresponding first time domain window and the second TCI state(s) may be applied during the corresponding second time domain window(s).

The network entity may transmit to the UE a second control signal (e.g., TCI state switching command 305) that triggers activation (e.g., switching) to the first TCI state during the first time domain window by the UE. When the first time domain window expires, the UE may switch to the second TCI state for communications during the second time domain window. When the second time domain window expires, the UE may switch to the next predicted TCI state (e.g., TCI-State #2) for communications during the corresponding time domain window. This switching, without additional TCI state switching commands being sent, may continue for N second TCI states during their corresponding N second time domain windows. For example, the UE may apply the QCL information associated with the TCI state during the corresponding time domain window.

As discussed above, the duration of each time domain window (e.g., T) of the first TCI state and the N second TCI state(s) may be equal (e.g., the same duration) or unequal (e.g., different durations). TCI scheme 300 illustrates non-limiting examples of how the indication of the time domain windows may be provided to the UE. That is, TCI scheme 300 illustrates non-limiting examples of how the identification of the time domain windows associated with the multiple predicted TCI states are communicated or otherwise determined by the network entity and/or the UE.

Identification of the time domain windows (i.e., values of T₀, T₁, T₂, . . . , T_{N}) associated with the multiple TCI-states indicated by network entity may be based on different options. A first option 310 may include the time offset being fixed or otherwise known by the wireless devices, such as being (pre)defined in the relevant standards. For example, the UE may apply the leading TCI-state right (e.g., the first TCI state) after it has received the TCI state switching command 305, and the remaining TCI-states should be switched to based on a standard predefined time domain offset. In some examples, the time domain offset may be differently standard defined for different remaining TCI-states.

A second option at 315 may include the network entity transmitting or otherwise providing (and the UE receiving or otherwise obtaining) an indication of the time offset between the first time domain window and the second time domain window. For example, the time offset (T) between the first and second time domain windows may be based on a starting time (e.g., a first starting time) of the first time domain window and a starting time (e.g., a second starting time) of the second time domain window, an ending time (e.g., a first ending time) of the first time domain window and an ending time (e.g., a second ending time) of the second time domain window, or a combination of starting and ending times. In some examples, the time offset (T) may refer to the respective duration of the first time domain window and/or the duration each of the second time domain window(s). The expiration of the first time domain window may be based, at least in some aspects, on the time offset. For example, the network entity may use RRC signaling to semi-statically (pre)configure the values for the time offsets (e.g., T). For example, the time domain offset discussed for the first option 310 may be network RRC (pre)configured for the UE. Such time domain offset can be differently RRC (pre)configured for different remaining TCI-states.

A third option at 320 may include the network entity dynamically defining the time offset for the first time domain window and the second time domain window. For example, the time offset may be dynamically indicated via MAC-CE and/or DCI signaling. That is, in some examples the first control signal may be a DCI signal that identifies or otherwise indicates the duration (e.g., values for T) for each time domain window of the TCI states activated for the UE, which may include the predicted TCI states in addition to the first time domain window.

Accordingly, the UE may switch to the first TCI state (TCI-State #0) for communications during the first time domain window having a duration of To based on the TCI state switching command 305. Upon expiration of the first time domain window, the UE may switch to the second TCI state (e.g., TCI-State #1) for communications during the second time domain window having a duration of T₁. The UE may continue, upon expiration of the current time domain window, to switch to the next TCI state (e.g., TCI-State #2) during the corresponding time domain windows having duration T₂ and so forth until the UE switches to the final predicted TCI state (e.g., TCI-State #N) for communications during the last time domain window having a duration T_{N}. For example, TCI state switching may be enabled at the UE without additional control signaling used to active and/or switch to each TCI state.

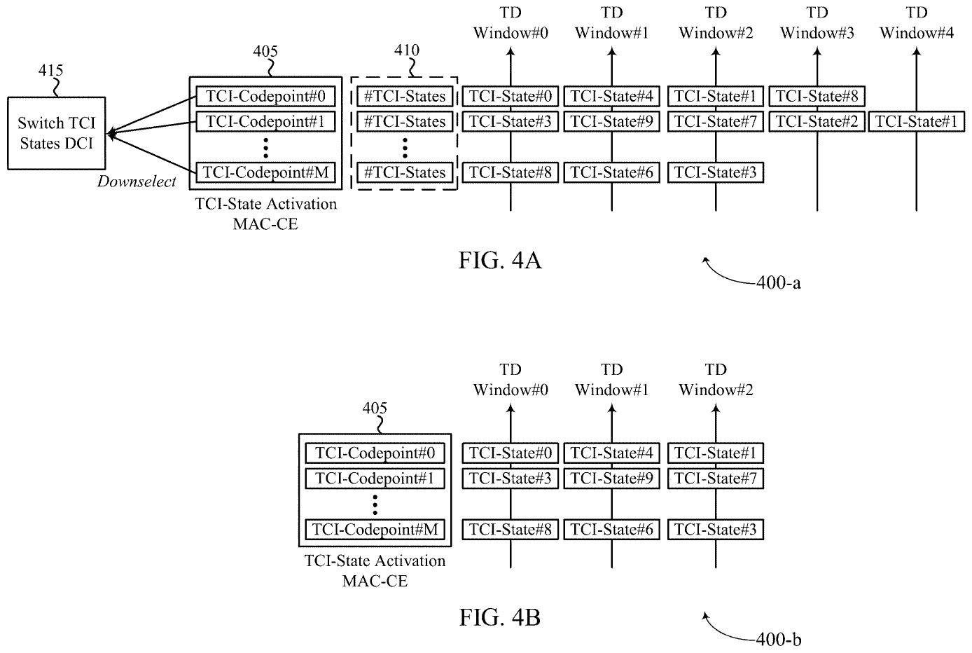

FIGS. 4A and 4B show examples of a TCI scheme 400 that supports indication of predicted TCI states in accordance with one or more aspects of the present disclosure. TCI scheme 400 may implement or be implemented by aspects of wireless communications system 100 or wireless communications system 200, and/or aspects of TCI scheme 300. Aspects of TCI scheme 400 may be implemented by or implemented by a UE and/or network entity, which may be examples of the corresponding devices described herein. TCI scheme 400-a of FIG. 4A illustrates a non-limiting example where a number of predicted TCI states per TCI codepoint is indicted per TCI codepoint. TCI scheme 400-b of FIG. 4B illustrates a non-limiting example where the number of predicted TCI states per TCI codepoint is fixed or otherwise known by the wireless devices.

As discussed above, the techniques described herein provide for the network signaling multiple predicted TCI states to be applied by the UE during corresponding time domain windows, with each predicted TCI state referring to second TCI state(s) and the corresponding time domain windows referring to second time domain window(s). The network entity may transmit to the UE a first control signal (e.g., a MAC-CE TCI activation signal 405) that identifies a first TCI state and the second TCI state(s). The first TCI state may be applied during a corresponding first time domain window and the second TCI state(s) may be applied during the corresponding second time domain window(s).

The network entity may transmit a second control signal (e.g., TCI state switching command via DCI 415) to the UE that triggers activation (e.g., switching) to the first TCI state during the first time domain window by the UE. When the first time domain window expires, the UE may switch to the second TCI state for communications during the second time domain window. When the second time domain window expires, the UE may switch to the next predicted TCI state (e.g., TCI-State #2) for communications during the corresponding time domain window. This switching, without additional TCI state switching commands being sent, may continue for N second TCI states during their corresponding N second time domain windows. For example, the UE may apply the QCL information associated with the TCI state during the corresponding time domain window.

In some aspects, the MAC-CE TCI activation signal 405 may include one or more codepoints (e.g., TCI-Codepoint #0, TCI-Codepoint #1, . . . , TCI-Codepoint #M) for the UE. Each TCI codepoint may generally refer to a set of bits (e.g., a plurality of bits), with each bit corresponding to a TCI state being activated (e.g., using a “1” bit) or being deactivated (e.g., using a “0” bit) for the UE. In some aspects, each TCI codepoint may activate or deactivate a first TCI state and second TCI state(s) for the UE. For example, TCI-Codepoint #0 may activate a first TCI state (e.g., TCI-State #0, in this example) during a first time domain window (e.g., TD Window #0) and second TCI state(s) (e.g., TCI-State #4, TCI-State #1, and TCI-State #8) for the UE during corresponding second time domain window(s) (e.g., TD Window #1, TD Window #2, and TD Window #3, in this example). TCI-Codepoint #1 may activate a first TCI state (e.g., TCI-State #3, in this example) during a first time domain window (e.g., TD Window #0) and second TCI state(s) (e.g., TCI-State #9, TCI-State #7, TCI-State #2, and TCI-State #1) for the UE during corresponding second time domain window(s) (e.g., TD Window #1, TD Window #2, TD Window #3, and TD Window #4, in this example). The final TCI codepoint (e.g., TCI-Codepoint #M, in this example) may activate a first TCI state (e.g., TCI-State #8, in this example) during a first time domain window (e.g., TD Window #0) and second TCI state(s) (e.g., TCI-State #6 and TCI-State #3, in this example) during corresponding second time domain windows (e.g., TD Window #1 and TD Window #2, in this example).

Thus, TCI scheme 400-a illustrates a non-limiting example where the TCI-state activation MAC-CE is enhanced to convey or otherwise indicate multiple TCI states (e.g., predicted TCI states) for corresponding, but different time domain windows per TCI-Codepoint. For example, the network entity indication may further be based on a MAC-CE activating TCI-States, wherein each TCI codepoint comprises the multiple TCI-states with respect to the corresponding multiple time domain windows. The actual TCI-state switching command may be received via DCI 415 by indicating a TCI codepoint from the most recently received TCI-state activation MAC-CE, e.g., the UE downselects the TCI codepoint indicated in the switching DCI based on the TCI codepoints indicated in the TCI state activation MAC-CE.

The TCI-state activation MAC-CE may be based on a separate MAC-CE which activates other conventional types of TCI-states. If so, the DCI switching TCI-state(s) may comprise further field(s) indicating which kind of MAC-CE is referred to when indicating the TCI-state(s) to be switched to. In some examples, the network entity may use RRC signaling to (pre)configure or a separate MAC-CE may be used to instruct to the UE which MAC-CE should be referred to when receiving such DCI. In some examples, the UE may not expect to receive such new MAC-CE together with conventional type(s) of MAC-CEs. When such TCI-state activation MAC-CE is used to jointly activate the predicted TCI states, together with other types of TCI-states, conventional joint/downlink/uplink TCI-state switching DCI format(s) may be reused.

Accordingly, the network may transmit or otherwise provide (and the UE may receive or otherwise obtain) one or more TCI codepoints in the first control signal (e.g., the TCI state activation MAC-CE). Each TCI codepoint may identify a set of predicted TCI states (e.g., second TCI state(s)) during the corresponding set of time domain windows (e.g., second time domain window(s)). The network may transmit or otherwise provide (and the UE may receive or otherwise obtain) an indication of a TCI codepoint in the second control signal (e.g., the DCI 415). The TCI codepoint indicated in the TCI switching DCI may be from the set of TCI codepoints indicated in the TCI state activation MAC-CE. Accordingly, the UE may use the TCI codepoint indicated in the TCI switching command to identify or otherwise select the corresponding TCI codepoint indicated in the TCI state activation MAC-CE. Based on the identified TCI codepoint indicated in the TCI switching DCI, the UE may identify or otherwise determine the first TCI state and second TCI state(s) to be used for communications with the network entity during the first time domain window and second time domain window(s), respectively.

TCI scheme 400-a of FIG. 4A illustrates a non-limiting example where the network includes an indication 410 of the number of predicted TCI states for each TCI codepoint. This indication 410 may include a variable TCI-State number and associated number of time domain windows, per TCI codepoint. Each TCI codepoint in the MAC-CE may further carry or otherwise convey (e.g., in a leading portion of the TCI codepoint) a field indicating the number of TCI states, and thus the number of associated time domain windows, for the corresponding TCI codepoint. The remaining fields of the TCI codepoint may sequentially indicates the corresponding number of RRC configured TCI state identifiers (e.g., using a bit or other information).

TCI scheme 400-b of FIG. 4B illustrates a non-limiting example where the number of TCI states per TCI codepoint indicated in the TCI state activation MAC CE is fixed or otherwise known. For example, there may be a common (e.g., the same) number of predicted TCI states per TCI codepoint. In some aspects, the fixed TCI state number, and associated number of time domain windows, per TCI codepoint. The number of TCI-states per TCI codepoint may be standards-based (e.g., (pre)defined) or RRC (pre)configured. The number of TCI states may be fixed (e.g., the same) across all TCI codepoints in the MAC-CE.

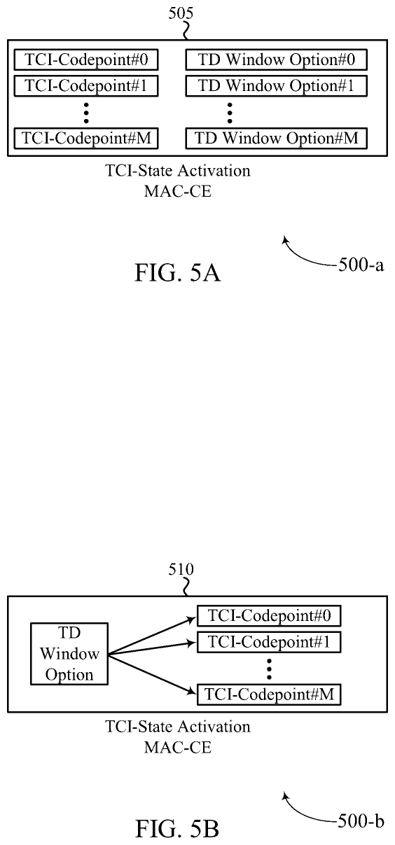

FIGS. 5A and 5B show examples of a TCI scheme 500 that supports indication of predicted TCI states in accordance with one or more aspects of the present disclosure. TCI scheme 500 may implement or be implemented by aspects of wireless communications system 100 or wireless communications system 200, and/or aspects of TCI scheme 300 or TCI scheme 400. Aspects of TCI scheme 500 may be implemented by or implemented by a UE and/or network entity, which may be examples of the corresponding devices described herein. TCI scheme 500-a of FIG. 5A illustrates a non-limiting example where a different time domain windows per TCI codepoint are indicated in the TCI state activation MAC-CE. TCI scheme 500-b of FIG. 5B illustrates a non-limiting example where an equal duration time domain window is indicated in the TCI state activation MAC-CE.

As discussed above, the techniques described herein provide for the network signaling multiple predicted TCI states to be applied by the UE during corresponding time domain windows, with each predicted TCI state referring to second TCI state(s) and the corresponding time domain windows referring to second time domain window(s). For example, the network entity may transmit to the UE a first control signal (e.g., a MAC-CE TCI activation signal 505) that identifies a first TCI state and the second TCI state(s). The first TCI state may be applied during a corresponding first time domain window and the second TCI state(s) may be applied during the corresponding second time domain window(s).

The network entity may transmit a second control signal (e.g., TCI state switching command) to the UE that triggers activation (e.g., switching) to the first TCI state during the first time domain window by the UE. When the first time domain window expires, the UE may switch to the second TCI state for communications during the second time domain window. When the second time domain window expires, the UE may switch to the next predicted TCI state for communications during the corresponding time domain window. This switching, without additional TCI state switching commands being sent, may continue for N second TCI states during their corresponding N second time domain windows. For example, the UE may apply the QCL information associated with the TCI state during the corresponding time domain window.

In some aspects, the MAC-CE TCI activation signal 505 may include one or more codepoints (e.g., TCI-Codepoint #0, TCI-Codepoint #1, . . . , TCI-Codepoint #M) for the UE. Each TCI codepoint may generally refer to a set of bits (e.g., a plurality of bits), with each bit corresponding to a TCI state being activated (e.g., using a “1” bit) or being deactivated (e.g., using a “0” bit) for the UE. In some aspects, each TCI codepoint may activate or deactivate a first TCI state and second TCI state(s) for the UE.

TCI scheme 500 illustrates a non-limiting example of TCI state activation MAC-CE enhancements with respect to different time domain windows per TCI codepoint. TCI scheme 500-a of FIG. 5A illustrates an example where the first control signal (e.g., the TCI state activation MAC-CE) carries or otherwise conveys an indication of a duration of a time domain window for each predicted TCI state.

That is, the time domain windows may also be indicated by or for each TCI codepoint indicated in the TCI state activation MAC-CE. For example, each TCI codepoint in the MAC-CE may include field(s) indicating values of (T₀, T₁, T₂, . . . , T_{N}) as discussed above, such that the duration of the time domain windows associated with the TCI states in the TCI codepoint are identified based on such values. In some examples, multiple options of (T₀, T₁, T₂, . . . , T_{N}) may be RRC (pre)configured, while the TCI codepoint selects one of the options. In some examples, the TCI codepoint may explicitly indicates a single value of T̅ such that T₀, T₁, T₂, . . . , T_{N}=T̅. In some examples, the TCI codepoint may indicate multiple options of (T₀, T₁, T₂, . . . , T_{N}), while the TCI state switching DCI includes additional field(s) that down-selects one of the options from such multiple options.

TCI scheme 500-b of FIG. 5B illustrates an example where the first control signal (e.g., the TCI state activation MAC-CE 510) carries or otherwise conveys an indication of an equal duration for the time domain window for each predicted TCI state. That is, the TCI state activation MAC-CE 515 may further include field(s) indicating values of (T₀, T₁, T₂, . . . , T_{N}), such that the time domain windows associated with all of the TCI codepoints may be identically identified (e.g., having equal or unequal durations) based on such values. For example, the TCI state activation MAC-CE 515 may explicitly indicate a single value of T̅ such that T₀, T₁, T₂, . . . , T_{N}=T̅ shall be applied to all TCI codepoints.

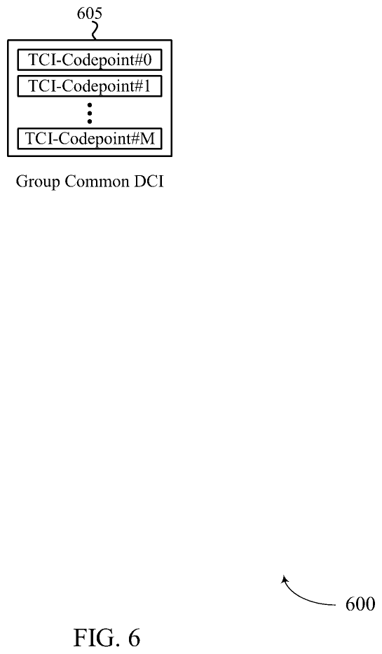

FIG. 6 shows an example of a TCI scheme 600 that supports indication of predicted TCI states in accordance with one or more aspects of the present disclosure. TCI scheme 600 may implement or be implemented by aspects of wireless communications system 100 or wireless communications system 200, and/or aspects of TCI scheme 300, TCI scheme 400, or TCI scheme 500. Aspects of TCI scheme 600 may be implemented by or implemented by a UE and/or network entity, which may be examples of the corresponding devices described herein.

As discussed above, the techniques described herein provide for the network signaling multiple predicted TCI states to be applied by the UE during corresponding time domain windows, with each predicted TCI state referring to second TCI state(s) and the corresponding time domain windows referring to second time domain window(s). The network entity may transmit to the UE a first control signal (e.g., a MAC-CE TCI activation signal) that identifies a first TCI state and the second TCI state(s). The first TCI state may be applied during a corresponding first time domain window and the second TCI state(s) may be applied during the corresponding second time domain window(s).

The network entity may transmit a second control signal (e.g., TCI state switching command 605) to the UE that triggers activation (e.g., switching) to the first TCI state during the first time domain window by the UE. When the first time domain window expires, the UE may switch to the second TCI state for communications during the second time domain window. When the second time domain window expires, the UE may switch to the next predicted TCI state for communications during the corresponding time domain window. This switching, without additional TCI state switching commands being sent, may continue for N second TCI states during their corresponding N second time domain windows. For example, the UE may apply the QCL information associated with the TCI state during the corresponding time domain window.

TCI scheme 600 illustrates a non-limiting example where a UE-group common TCI state switch DCI command is used as the second control signal. That is, the UE may receive the second control signal via a group common DCI. The UE may belong to the group associated with the group common DCI. In other examples, it is to be understood that the first control signal (e.g., the TCI state activation MAC-CE) may carry or otherwise convey an indication that the UE belongs to the group common DCI. Although not shown, in other examples the second control signal may be received in a UE-specific DCI.

Accordingly, TCI scheme 600 illustrates a non-limiting example where a UE-group common TCI-state switch DCI command is used to trigger activation (e.g., switching) of the first TCI state. The UE may receive the group-common DCI comprising N blocks (e.g., a new DCI format and/or a new RNTI). Each block may refer to a TCI codepoint in the most recently received MAC-CE (e.g., most recent TCI state activation MAC-CE). The UE may identify an RRC (pre)configured parameter (e.g., Block-ID-TCI-Predict) such that the UE may refer to the Block-ID-TCI-Predict^{th} block within the group-common DCI to identify the TCI-states to be switched to.

As discussed, in some examples the first control signal (e.g., the TCI state activation MAC-CE) may carry or otherwise convey an indication that the UE belongs to the group common DCI. Accordingly, the Block-ID may be updated via MAC-CE. For example, the RRC (pre)configured parameter Block-ID-TCI-Predict may be dynamically updated by MAC-CE (e.g., the TCI state activation MAC-CE or a different MAC-CE). The MAC-CE may include an additional field that includes updated value of Block-ID-TCI-Predict, thus assigning the UE to a different UE group used for subsequent group common TCI state switching command(s).

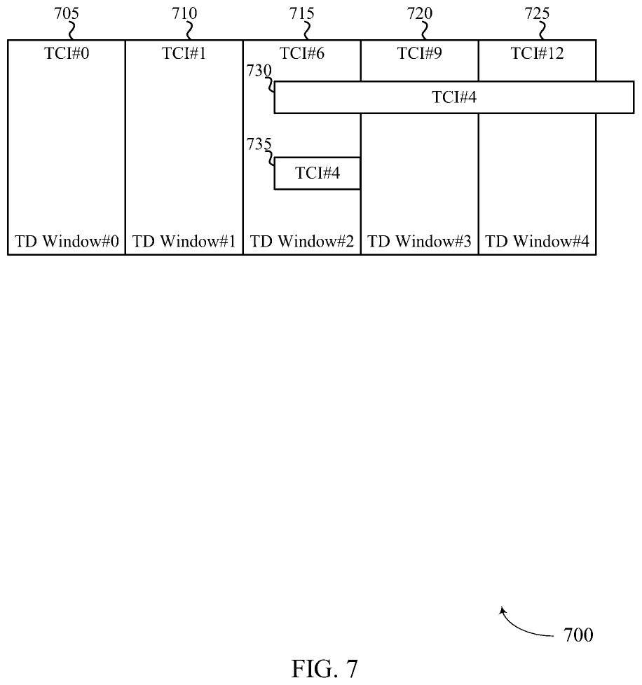

FIG. 7 shows an example of a TCI scheme 700 that supports indication of predicted TCI states in accordance with one or more aspects of the present disclosure. TCI scheme 700 may implement or be implemented by aspects of wireless communications system 100 or wireless communications system 200, and/or aspects of TCI scheme 300, TCI scheme 400, TCI scheme 500, or TCI scheme 600. Aspects of TCI scheme 700 may be implemented by or implemented by a UE and/or network entity, which may be examples of the corresponding devices described herein.

As discussed above, the techniques described herein provide for the network signaling multiple predicted TCI states to be applied by the UE during corresponding time domain windows, with each predicted TCI state referring to second TCI state(s) and the corresponding time domain windows referring to second time domain window(s). The network entity may transmit to the UE a first control signal (e.g., a MAC-CE TCI activation signal) that identifies a first TCI state 705 and the second TCI state(s) (e.g., TCI state 710, TCI state 715, TCI state 720, and TCI state 725). The first TCI state 705 may be applied during a corresponding first time domain window (e.g., during TD Window #0) and the second TCI state(s) may be applied during the corresponding second time domain window(s) (e.g., during TD Window #1, TD Window #2, TD Window #3, and TD Window #4, respectively).

The network entity may transmit a second control signal (e.g., TCI state switching command) to the UE that triggers activation (e.g., switching) to the first TCI state 705 during the first time domain window by the UE. When the first time domain window expires, the UE may switch to the second TCI state (e.g., TCI state 710) for communications during the second time domain window. When the second time domain window expires, the UE may switch to the next predicted TCI state (e.g., TCI state 715, in this example) for communications during the corresponding time domain window. This switching, without additional TCI state switching commands being sent, may continue for N second TCI states during their corresponding N second time domain windows, with N=four in the non-limiting example shown in FIG. 7. For example, the UE may apply the QCL information associated with the TCI state during the corresponding time domain window.

TCI scheme 700 illustrates a non-limiting example where a previously activated and switched predicted TCI state is overridden by the network. For example, prior to the second time domain window (e.g., TD Window #1, TD Window #2, TD Window #3, or TD Window #4) the UE may receive or otherwise obtain a third control signal triggering activation of an updated TCI state during the second time domain window. In response, the UE override switching to the second TCI state during the corresponding second time domain window. Instead, the UE may switch to the updated TCI state during the second time domain window for communications with the network entity.

Accordingly, TCI scheme 700 illustrates a non-limiting example where ethe predicted TCI states are overwritten by an instantaneously switched TCI state. The TCI-states activated via MAC-CE (e.g., in the first control signal) and then switched by conventional DCI or group-common DCI (e.g., the second control signal), may be overwritten by conventional single-shot TCI-state switch command. For example, consider the K^{th} time domain window (wherein 0≤K≤N) regarding the K^{th} TCI-state. In the non-limiting example illustrated in FIG. 7, the Kth time domain window corresponds to the TD Window #2 during which the TCI state 715 had been previously activated and switched. If the UE receives a TCI-state switching command (e.g., a DCI-based TCI state switching command) triggering activation (e.g., switching) to an updated TCI state immediately, the UE shall switch to such TCI-state immediately and ignore the K^{th} TCI-state associated with the K^{th} time domain window.

In one non-limiting example, this may include the UE switching to the updated TCI state 730 (e.g., TCI-State #4, in this example) during the TD Window #2 rather than switching to TCI-State #6 previously predicted for the TD Window #2. In this example, the UE may continue to apply the updated TCI state (e.g., TCI-State #4) for the remaining time domain windows (e.g., during TD Window #3 and TD Window #4) in response to the indication of the updated TCI state switching command.

In another non-limiting example, this may include the UE switching to the updated TCI state 735 (e.g., TCI-State #4, in this example) during the TD Window #2 rather than switching to the TCI-State #6 previously predicted for the TD Window #2. However, in this example the UE may return to (e.g., switch to) the previously configured predicted TCI states (e.g., second TCI state(s)) during the corresponding time domain window(s). For example, the UE may switch to TCI-State #9 during TD Window #3 and switch to TCI-State #12 during TD Window #4.

Whether the UE resumes switching to the predicted TCI-states for the (K+1)^{th}, (K+2)^{th}, . . . , N^{th} time domain window, may be further based on standard (pre)definition and/or based on further configuration/indication from the network entity.

For example, the relevant standards may (pre)define that the UE should resume using the predicted TCI-states once reaching the (K+1)^{th}, (K+2)^{th}, . . . , N^{th} time domain windows. As another example, the relevant standards may (pre)define that the UE should ignore the remaining predicted TCI-states regarding the (K+1)^{th}, (K+2)^{th}, . . . , N^{th} time domain windows.

In another example, the network entity may RRC (pre)configure whether the UE should resume or ignore the predicted TCI states during the corresponding time domain windows. For example, the network entity may use MAC-CE and/or DCI signaling to dynamically indicate whether the UE should resume or ignore the predicted TCI states. The MAC-CE signaling may include the first control signal discussed above or may be a different MAC-CE.

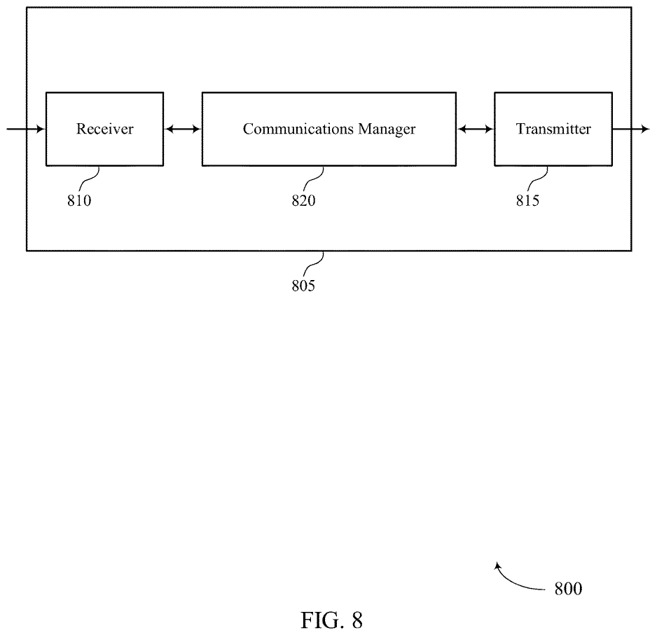

FIG. 8 shows a block diagram 800 of a device 805 that supports indication of predicted TCI states in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to indication of predicted TCI states). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to indication of predicted TCI states). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of indication of predicted TCI states as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 is capable of, configured to, or operable to support a means for receiving a first control signal indicating a first TCI state for a first time domain window and a second TCI state for a second time domain window that is subsequent to the first time domain window, the second TCI state including a predicted TCI state. The communications manager 820 is capable of, configured to, or operable to support a means for receiving a second control signal triggering activation of the first TCI state for communications during the first time domain window based on the first control signal. The communications manager 820 is capable of, configured to, or operable to support a means for switching, according to the second control signal, to the second TCI state for communications during the second time domain window based on the first control signal and an expiration of the first time domain window.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced control signaling overhead by indicating a set of predicted TCI states to be applied by the UE and network for communications during corresponding time domain windows.

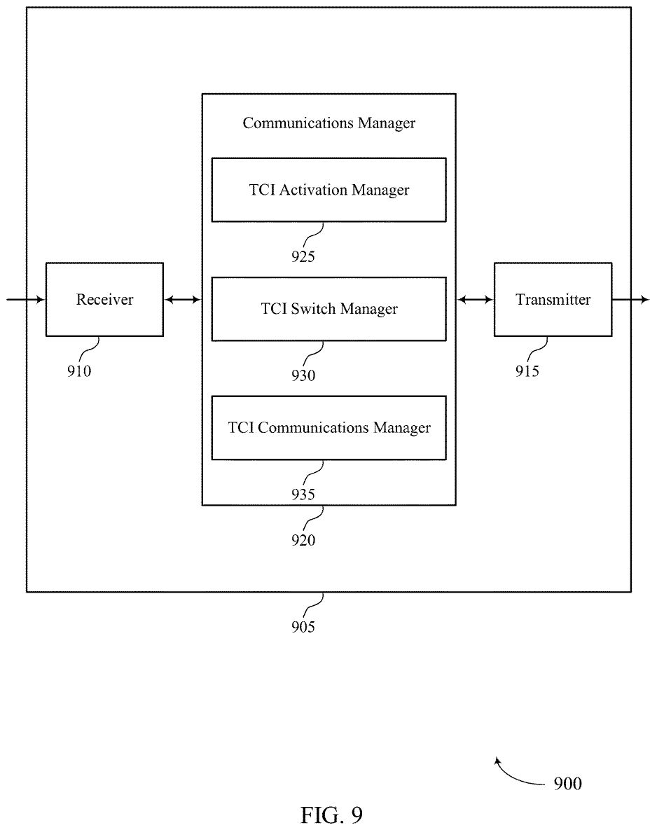

FIG. 9 shows a block diagram 900 of a device 905 that supports indication of predicted TCI states in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to indication of predicted TCI states). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to indication of predicted TCI states). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of indication of predicted TCI states as described herein. For example, the communications manager 920 may include a TCI activation manager 925, a TCI switch manager 930, a TCI communications manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The TCI activation manager 925 is capable of, configured to, or operable to support a means for receiving a first control signal indicating a first TCI state for a first time domain window and a second TCI state for a second time domain window that is subsequent to the first time domain window, the second TCI state including a predicted TCI state. The TCI switch manager 930 is capable of, configured to, or operable to support a means for receiving a second control signal triggering activation of the first TCI state for communications during the first time domain window based on the first control signal. The TCI communications manager 935 is capable of, configured to, or operable to support a means for switching, according to the second control signal, to the second TCI state for communications during the second time domain window based on the first control signal and an expiration of the first time domain window.

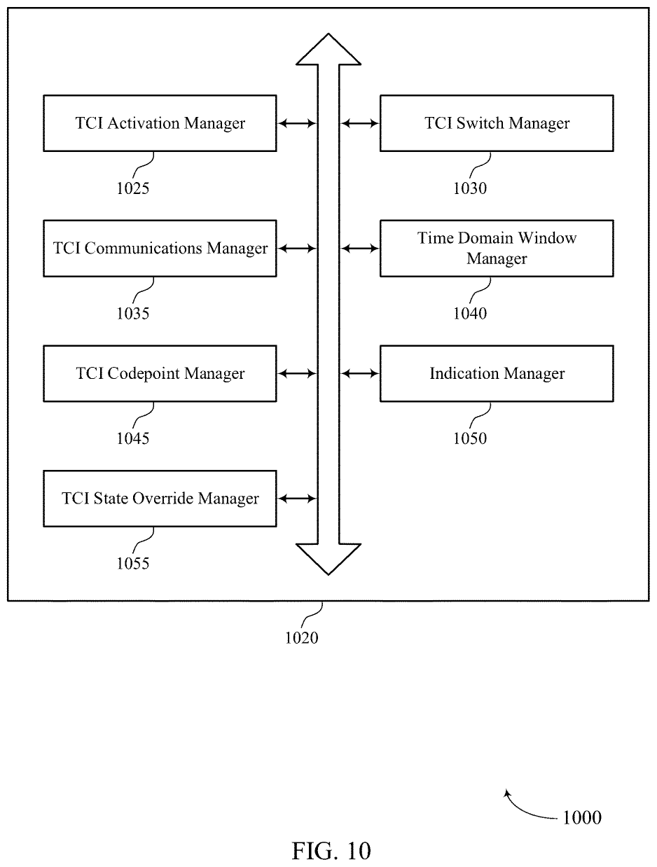

FIG. 10 shows a block diagram 1000 of a communications manager 1020 that supports indication of predicted TCI states in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of indication of predicted TCI states as described herein. For example, the communications manager 1020 may include a TCI activation manager 1025, a TCI switch manager 1030, a TCI communications manager 1035, a time domain window manager 1040, a TCI codepoint manager 1045, an indication manager 1050, a TCI state override manager 1055, or any combination thereof. Each of these components may communicate, directly or indirectly, with one another (e.g., via one or more buses).

The communications manager 1020 may support wireless communications at a UE in accordance with examples as disclosed herein. The TCI activation manager 1025 is capable of, configured to, or operable to support a means for receiving a first control signal indicating a first TCI state for a first time domain window and a second TCI state for a second time domain window that is subsequent to the first time domain window, the second TCI state including a predicted TCI state. The TCI switch manager 1030 is capable of, configured to, or operable to support a means for receiving a second control signal triggering activation of the first TCI state for communications during the first time domain window based on the first control signal. The TCI communications manager 1035 is capable of, configured to, or operable to support a means for switching, according to the second control signal, to the second TCI state for communications during the second time domain window based on the first control signal and an expiration of the first time domain window.

In some examples, to support receiving the first control signal, the time domain window manager 1040 is capable of, configured to, or operable to support a means for receiving an indication of a time offset between a first ending time of the first time domain window and a second ending time of the second time domain window, where the expiration of the first time domain window is based on the time offset.

In some examples, to support receiving the first control signal, the time domain window manager 1040 is capable of, configured to, or operable to support a means for receiving an RRC signal that semi-statically defines the time offset between the first time domain window and the second time domain window.

In some examples, to support receiving the first control signal, the time domain window manager 1040 is capable of, configured to, or operable to support a means for receiving downlink control information that dynamically defines the time offset between the first time domain window and the second time domain window.

In some examples, to support receiving the first control signal, the time domain window manager 1040 is capable of, configured to, or operable to support a means for receiving an indication of a set of multiple time domain windows that includes the first time domain window and the second time domain window, where a sequentially last time domain window of the set of multiple time domain windows is associated with an undefined ending point. In some examples, a duration of the second time domain window is based on a duration of the first time domain window in accordance with a defined ratio. In some examples, the first time domain window and the second time domain window are equal in duration. In some examples, the first time domain window and the second time domain window are unequal in duration.

In some examples, the TCI codepoint manager 1045 is capable of, configured to, or operable to support a means for receiving, via the first control signal, one or more TCI state codepoints, each TCI state codepoint identifying a set of predicted TCI states during a corresponding set of second time domain windows, the set of predicted TCI states based on the second TCI state. In some examples, the TCI codepoint manager 1045 is capable of, configured to, or operable to support a means for receiving, via the second control signal, a TCI state codepoint from the one or more TCI state codepoints, where switching to the second TCI state is based on receiving the TCI state codepoint.

In some examples, the TCI codepoint manager 1045 is capable of, configured to, or operable to support a means for receiving, via the first control signal, for each TCI state codepoint in the one or more TCI state codepoints, an indication of a number of predicted TCI states for the TCI state codepoint. In some examples, each TCI state codepoint in the one or more TCI state codepoints includes a common number of predicted TCI states.

In some examples, the TCI codepoint manager 1045 is capable of, configured to, or operable to support a means for receiving, via the second control signal, for each TCI state codepoint in the one or more TCI state codepoints, an indication of a duration of a time domain window for each predicted TCI state in the set of predicted TCI states, where the second time domain window is based on the duration. In some examples, the second time domain window includes the equal duration.

In some examples, the indication manager 1050 is capable of, configured to, or operable to support a means for receiving the first control signal via a group common MAC-CE, where the UE belongs to a group of UEs associated with the group common MAC-CE.

In some examples, the indication manager 1050 is capable of, configured to, or operable to support a means for receiving the second control signal via a group common DCI, where the UE belongs to a group of UEs associated with the group common DCI. In some examples, the first control signal indicates that the UE belongs to the group of UEs.

In some examples, the indication manager 1050 is capable of, configured to, or operable to support a means for receiving the second control signal via a UE-specific DCI.

In some examples, the TCI state override manager 1055 is capable of, configured to, or operable to support a means for receiving, prior to the second time domain window, a third control signal triggering activation of an updated TCI state during the second time domain window. In some examples, the TCI state override manager 1055 is capable of, configured to, or operable to support a means for overriding switching to the second TCI state and switching to the updated TCI state during the second time domain window based on the third control signal.

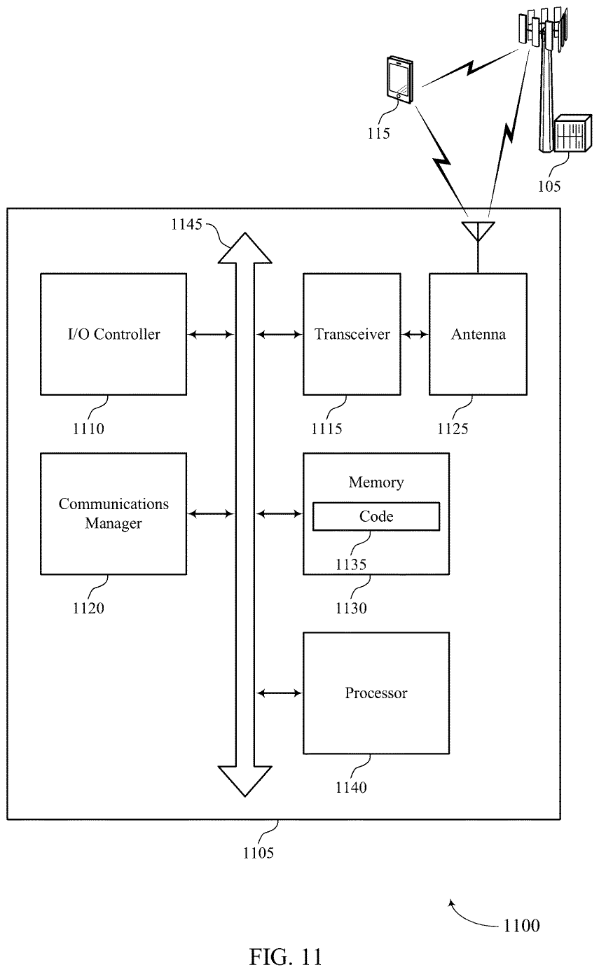

FIG. 11 shows a diagram of a system 1100 including a device 1105 that supports indication of predicted TCI states in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting indication of predicted TCI states). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 is capable of, configured to, or operable to support a means for receiving a first control signal indicating a first TCI state for a first time domain window and a second TCI state for a second time domain window that is subsequent to the first time domain window, the second TCI state including a predicted TCI state. The communications manager 1120 is capable of, configured to, or operable to support a means for receiving a second control signal triggering activation of the first TCI state for communications during the first time domain window based on the first control signal. The communications manager 1120 is capable of, configured to, or operable to support a means for switching, according to the second control signal, to the second TCI state for communications during the second time domain window based on the first control signal and an expiration of the first time domain window.

By including or configuring the communications manager 1120 in accordance with examples as described herein, the device 1105 may support techniques for reduced control signaling overhead by indicating a set of predicted TCI states to be applied by the UE and network for communications during corresponding time domain windows.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of indication of predicted TCI states as described herein, or the processor 1140 and the memory 1130 may be otherwise configured to perform or support such operations.

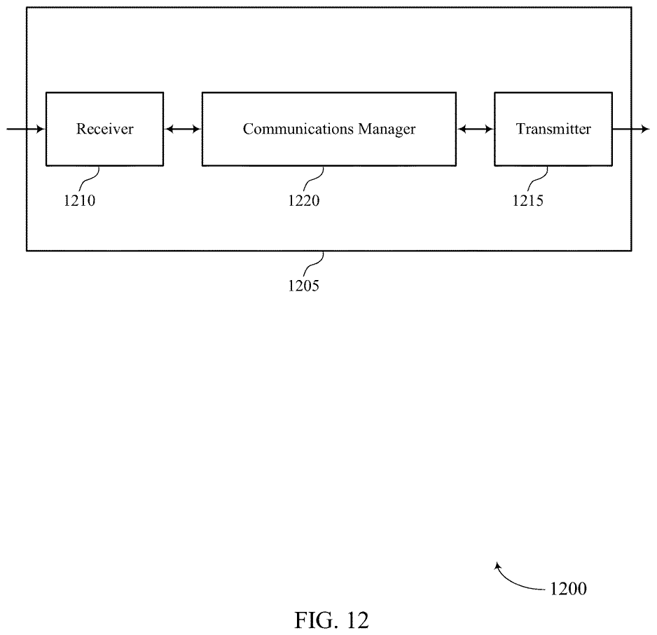

FIG. 12 shows a block diagram 1200 of a device 1205 that supports indication of predicted TCI states in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of indication of predicted TCI states as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. For example, the communications manager 1220 is capable of, configured to, or operable to support a means for transmitting, to a UE, a first control signal indicating a first TCI state for a first time domain window and a second TCI state for a second time domain window that is subsequent to the first time domain window, the second TCI state including a predicted TCI state. The communications manager 1220 is capable of, configured to, or operable to support a means for transmitting a second control signal to the UE triggering activation of the first TCI state for communications during the first time domain window based on the first control signal. The communications manager 1220 is capable of, configured to, or operable to support a means for communicating with the UE, according to the second control signal, using the second TCI state during the second time domain window based on the first control signal and an expiration of the first time domain window.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced control signaling overhead by indicating a set of predicted TCI states to be applied by the UE and network for communications during corresponding time domain windows.

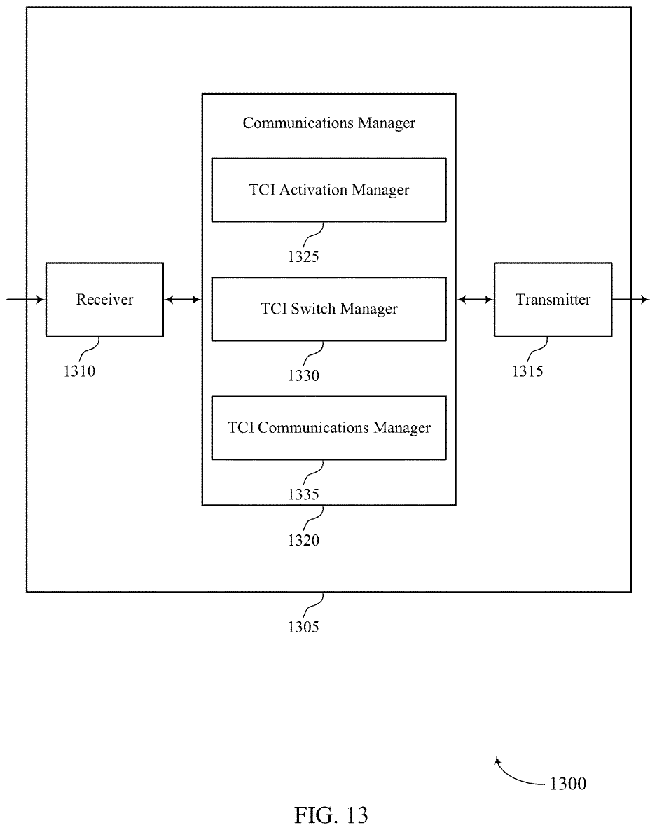

FIG. 13 shows a block diagram 1300 of a device 1305 that supports indication of predicted TCI states in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas.

Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of indication of predicted TCI states as described herein. For example, the communications manager 1320 may include a TCI activation manager 1325, a TCI switch manager 1330, a TCI communications manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. The TCI activation manager 1325 is capable of, configured to, or operable to support a means for transmitting, to a UE, a first control signal indicating a first TCI state for a first time domain window and a second TCI state for a second time domain window that is subsequent to the first time domain window, the second TCI state including a predicted TCI state. The TCI switch manager 1330 is capable of, configured to, or operable to support a means for transmitting a second control signal to the UE triggering activation of the first TCI state for communications during the first time domain window based on the first control signal. The TCI communications manager 1335 is capable of, configured to, or operable to support a means for communicating with the UE, according to the second control signal, using the second TCI state during the second time domain window based on the first control signal and an expiration of the first time domain window.

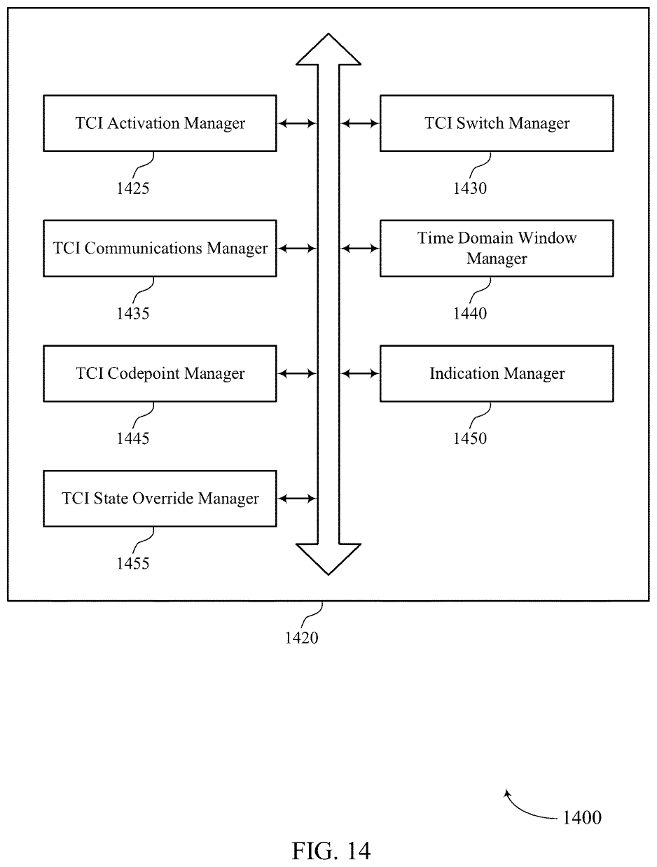

FIG. 14 shows a block diagram 1400 of a communications manager 1420 that supports indication of predicted TCI states in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of indication of predicted TCI states as described herein. For example, the communications manager 1420 may include a TCI activation manager 1425, a TCI switch manager 1430, a TCI communications manager 1435, a time domain window manager 1440, a TCI codepoint manager 1445, an indication manager 1450, a TCI state override manager 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples as disclosed herein. The TCI activation manager 1425 is capable of, configured to, or operable to support a means for transmitting, to a UE, a first control signal indicating a first TCI state for a first time domain window and a second TCI state for a second time domain window that is subsequent to the first time domain window, the second TCI state including a predicted TCI state. The TCI switch manager 1430 is capable of, configured to, or operable to support a means for transmitting a second control signal to the UE triggering activation of the first TCI state for communications during the first time domain window based on the first control signal. The TCI communications manager 1435 is capable of, configured to, or operable to support a means for communicating with the UE, according to the second control signal, using the second TCI state during the second time domain window based on the first control signal and an expiration of the first time domain window.

In some examples, to support transmitting the first control signal, the time domain window manager 1440 is capable of, configured to, or operable to support a means for transmitting an indication of a time offset between a first ending time of the first time domain window and a second ending time of the second time domain window, where the expiration of the first time domain window is based on the time offset.

In some examples, to support transmitting the first control signal, the time domain window manager 1440 is capable of, configured to, or operable to support a means for transmitting an RRC signal that semi-statically defines the time offset between the first time domain window and the second time domain window.

In some examples, to support transmitting the first control signal, the time domain window manager 1440 is capable of, configured to, or operable to support a means for transmitting downlink control information that dynamically defines the time offset between the first time domain window and the second time domain window.

In some examples, to support transmitting the first control signal, the time domain window manager 1440 is capable of, configured to, or operable to support a means for transmitting an indication of a set of multiple time domain windows that includes the first time domain window and the second time domain window, where a sequentially last time domain window of the set of multiple time domain windows is associated with an undefined ending point. In some examples, a duration of the second time domain window is based on a duration of the first time domain window in accordance with a defined ratio. In some examples, the first time domain window and the second time domain window are equal in duration. In some examples, the first time domain window and the second time domain window are unequal in duration.

In some examples, the TCI codepoint manager 1445 is capable of, configured to, or operable to support a means for transmitting, via the first control signal, one or more TCI state codepoints, each TCI state codepoint identifying a set of predicted TCI states during a corresponding set of second time domain windows, the set of predicted TCI states based on the second TCI state. In some examples, the TCI codepoint manager 1445 is capable of, configured to, or operable to support a means for transmitting, via the second control signal, a TCI state codepoint from the one or more TCI state codepoints, where communicating with the UE using the second TCI state is based on transmitting the TCI state codepoint.

In some examples, the TCI codepoint manager 1445 is capable of, configured to, or operable to support a means for transmitting, via the first control signal, for each TCI state codepoint in the one or more TCI state codepoints, an indication of a number of predicted TCI states for the TCI state codepoint. In some examples, each TCI state codepoint in the one or more TCI state codepoints includes a common number of predicted TCI states.

In some examples, the TCI codepoint manager 1445 is capable of, configured to, or operable to support a means for transmitting, via the second control signal, for each TCI state codepoint in the one or more TCI state codepoints, an indication of a duration of a time domain window for each predicted TCI state in the set of predicted TCI states, where the second time domain window is based on the duration. In some examples, the second time domain window includes the equal duration.

In some examples, the indication manager 1450 is capable of, configured to, or operable to support a means for transmitting the first control signal via a group common MAC-CE, where the UE belongs to a group of UEs associated with the group common MAC-CE.

In some examples, the indication manager 1450 is capable of, configured to, or operable to support a means for transmitting the second control signal via a group common DCI, where the UE belongs to a group of UEs associated with the group common DCI. In some examples, the first control signal indicates that the UE belongs to the group of UEs.

In some examples, the indication manager 1450 is capable of, configured to, or operable to support a means for transmitting the second control signal via a UE-specific DCI.

In some examples, the TCI state override manager 1455 is capable of, configured to, or operable to support a means for transmitting, prior to the second time domain window, a third control signal triggering activation of an updated TCI state during the second time domain window. In some examples, the TCI state override manager 1455 is capable of, configured to, or operable to support a means for overriding a switch to the second TCI state and switching to the updated TCI state during the second time domain window based on the third control signal.

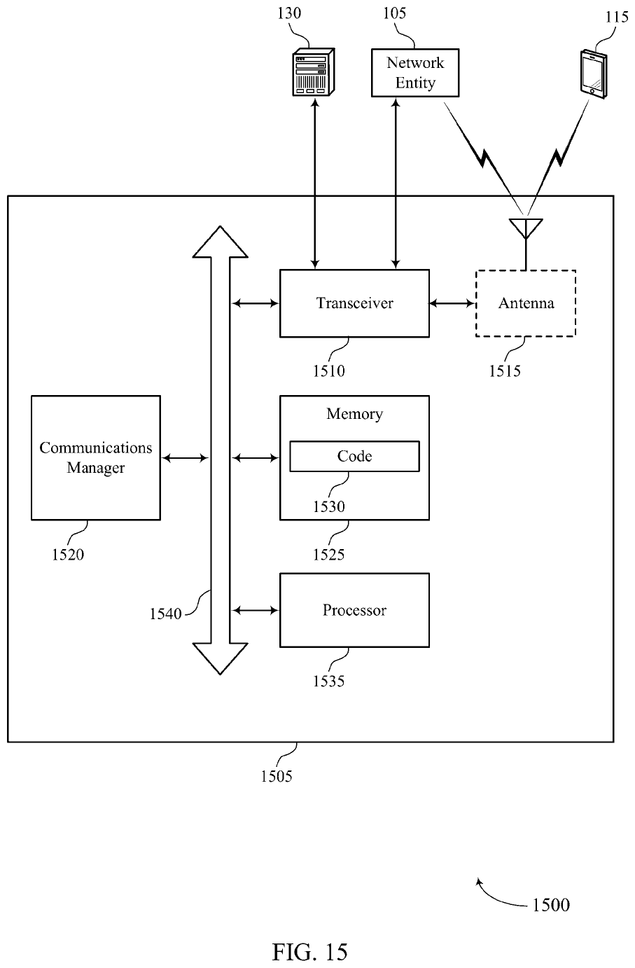

FIG. 15 shows a diagram of a system 1500 including a device 1505 that supports indication of predicted TCI states in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting indication of predicted TCI states). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a network entity in accordance with examples as disclosed herein. For example, the communications manager 1520 is capable of, configured to, or operable to support a means for transmitting, to a UE, a first control signal indicating a first TCI state for a first time domain window and a second TCI state for a second time domain window that is subsequent to the first time domain window, the second TCI state including a predicted TCI state. The communications manager 1520 is capable of, configured to, or operable to support a means for transmitting a second control signal to the UE triggering activation of the first TCI state for communications during the first time domain window based on the first control signal. The communications manager 1520 is capable of, configured to, or operable to support a means for communicating with the UE, according to the second control signal, using the second TCI state during the second time domain window based on the first control signal and an expiration of the first time domain window.

By including or configuring the communications manager 1520 in accordance with examples as described herein, the device 1505 may support techniques for reduced control signaling overhead by indicating a set of predicted TCI states to be applied by the UE and network for communications during corresponding time domain windows.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of indication of predicted TCI states as described herein, or the processor 1535 and the memory 1525 may be otherwise configured to perform or support such operations.

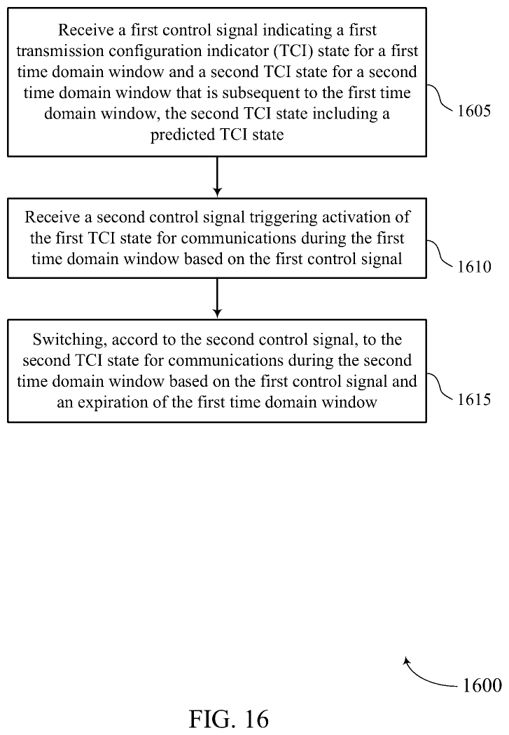

FIG. 16 shows a flowchart illustrating a method 1600 that supports indication of predicted TCI states in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving a first control signal indicating a first TCI state for a first time domain window and a second TCI state for a second time domain window that is subsequent to the first time domain window, the second TCI state including a predicted TCI state. The operations of 1605 may be performed in accordance with examples as disclosed herein. In some examples, aspects of the operations of 1605 may be performed by a TCI activation manager 1025 as described with reference to FIG. 10.

At 1610, the method may include receiving a second control signal triggering activation of the first TCI state for communications during the first time domain window based on the first control signal. The operations of 1610 may be performed in accordance with examples as disclosed herein. In some examples, aspects of the operations of 1610 may be performed by a TCI switch manager 1030 as described with reference to FIG. 10.

At 1615, the method may include switching, according to the second control signal, to the second TCI state for communications during the second time domain window based on the first control signal and an expiration of the first time domain window. The operations of 1615 may be performed in accordance with examples as disclosed herein. In some examples, aspects of the operations of 1615 may be performed by a TCI communications manager 1035 as described with reference to FIG. 10.

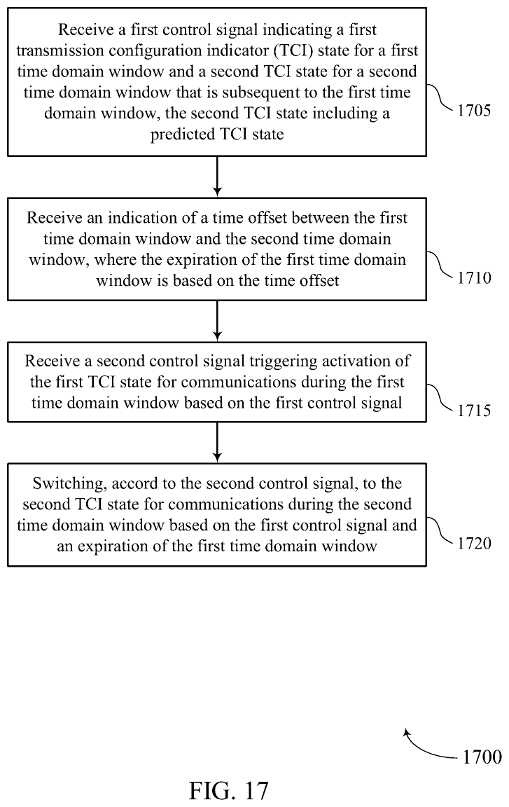

FIG. 17 shows a flowchart illustrating a method 1700 that supports indication of predicted TCI states in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving a first control signal indicating a first TCI state for a first time domain window and a second TCI state for a second time domain window that is subsequent to the first time domain window, the second TCI state including a predicted TCI state. The operations of 1705 may be performed in accordance with examples as disclosed herein. In some examples, aspects of the operations of 1705 may be performed by a TCI activation manager 1025 as described with reference to FIG. 10.

At 1710, the method may include receiving an indication of a time offset between a first ending time of the first time domain window and a second ending time of the second time domain window, where the expiration of the first time domain window is based on the time offset. The operations of 1710 may be performed in accordance with examples as disclosed herein. In some examples, aspects of the operations of 1710 may be performed by a time domain window manager 1040 as described with reference to FIG. 10.

At 1715, the method may include receiving a second control signal triggering activation of the first TCI state for communications during the first time domain window based on the first control signal. The operations of 1715 may be performed in accordance with examples as disclosed herein. In some examples, aspects of the operations of 1715 may be performed by a TCI switch manager 1030 as described with reference to FIG. 10.

At 1720, the method may include switching, according to the second control signal, to the second TCI state for communications during the second time domain window based on the first control signal and an expiration of the first time domain window. The operations of 1720 may be performed in accordance with examples as disclosed herein. In some examples, aspects of the operations of 1720 may be performed by a TCI communications manager 1035 as described with reference to FIG. 10.

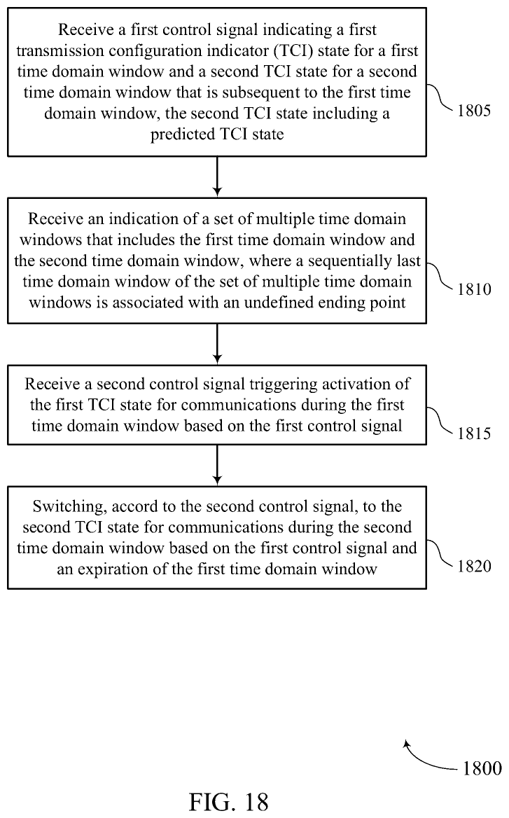

FIG. 18 shows a flowchart illustrating a method 1800 that supports indication of predicted TCI states in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1805, the method may include receiving a first control signal indicating a first TCI state for a first time domain window and a second TCI state for a second time domain window that is subsequent to the first time domain window, the second TCI state including a predicted TCI state. The operations of 1805 may be performed in accordance with examples as disclosed herein. In some examples, aspects of the operations of 1805 may be performed by a TCI activation manager 1025 as described with reference to FIG. 10.

At 1810, the method may include receiving an indication of a set of multiple time domain windows that includes the first time domain window and the second time domain window, where a sequentially last time domain window of the set of multiple time domain windows is associated with an undefined ending point. The operations of 1810 may be performed in accordance with examples as disclosed herein. In some examples, aspects of the operations of 1810 may be performed by a time domain window manager 1040 as described with reference to FIG. 10.

At 1815, the method may include receiving a second control signal triggering activation of the first TCI state for communications during the first time domain window based on the first control signal. The operations of 1815 may be performed in accordance with examples as disclosed herein. In some examples, aspects of the operations of 1815 may be performed by a TCI switch manager 1030 as described with reference to FIG. 10.

At 1820, the method may include switching, according to the second control signal, to the second TCI state for communications during the second time domain window based on the first control signal and an expiration of the first time domain window. The operations of 1820 may be performed in accordance with examples as disclosed herein. In some examples, aspects of the operations of 1820 may be performed by a TCI communications manager 1035 as described with reference to FIG. 10.

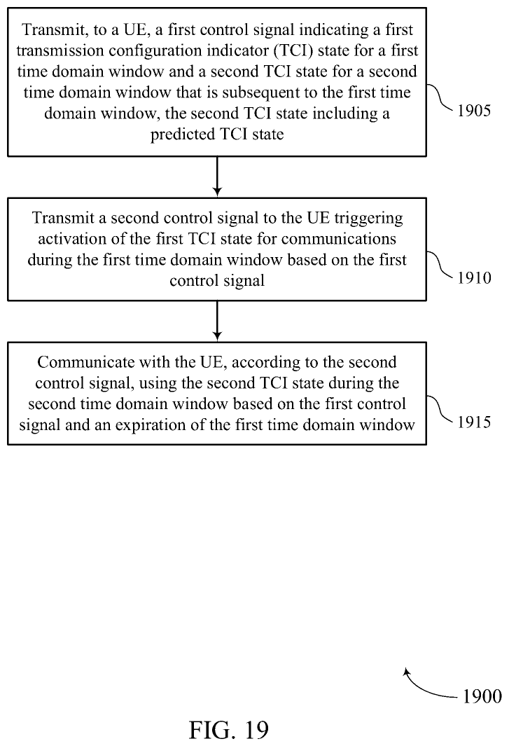

FIG. 19 shows a flowchart illustrating a method 1900 that supports indication of predicted TCI states in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include transmitting, to a UE, a first control signal indicating a first TCI state for a first time domain window and a second TCI state for a second time domain window that is subsequent to the first time domain window, the second TCI state including a predicted TCI state. The operations of 1905 may be performed in accordance with examples as disclosed herein. In some examples, aspects of the operations of 1905 may be performed by a TCI activation manager 1425 as described with reference to FIG. 14.

At 1910, the method may include transmitting a second control signal to the UE triggering activation of the first TCI state for communications during the first time domain window based on the first control signal. The operations of 1910 may be performed in accordance with examples as disclosed herein. In some examples, aspects of the operations of 1910 may be performed by a TCI switch manager 1430 as described with reference to FIG. 14.

At 1915, the method may include communicating with the UE, according to the second control signal, using the second TCI state during the second time domain window based on the first control signal and an expiration of the first time domain window. The operations of 1915 may be performed in accordance with examples as disclosed herein. In some examples, aspects of the operations of 1915 may be performed by a TCI communications manager 1435 as described with reference to FIG. 14.

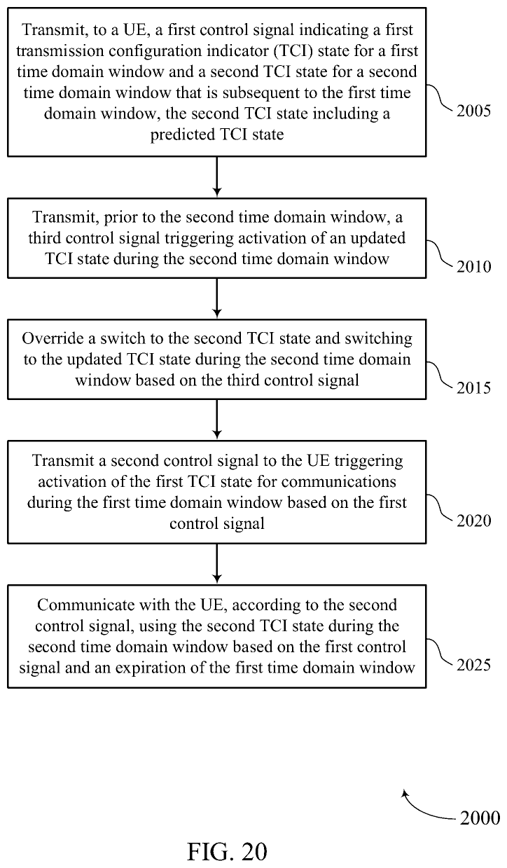

FIG. 20 shows a flowchart illustrating a method 2000 that supports indication of predicted TCI states in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2005, the method may include transmitting, to a UE, a first control signal indicating a first TCI state for a first time domain window and a second TCI state for a second time domain window that is subsequent to the first time domain window, the second TCI state including a predicted TCI state. The operations of 2005 may be performed in accordance with examples as disclosed herein. In some examples, aspects of the operations of 2005 may be performed by a TCI activation manager 1425 as described with reference to FIG. 14.

At 2010, the method may include transmitting, prior to the second time domain window, a third control signal triggering activation of an updated TCI state during the second time domain window. The operations of 2010 may be performed in accordance with examples as disclosed herein. In some examples, aspects of the operations of 2010 may be performed by a TCI state override manager 1455 as described with reference to FIG. 14.

At 2015, the method may include overriding a switch to the second TCI state and switching to the updated TCI state during the second time domain window based on the third control signal. The operations of 2015 may be performed in accordance with examples as disclosed herein. In some examples, aspects of the operations of 2015 may be performed by a TCI state override manager 1455 as described with reference to FIG. 14.

At 2020, the method may include transmitting a second control signal to the UE triggering activation of the first TCI state for communications during the first time domain window based on the first control signal. The operations of 2020 may be performed in accordance with examples as disclosed herein. In some examples, aspects of the operations of 2020 may be performed by a TCI switch manager 1430 as described with reference to FIG. 14.

At 2025, the method may include communicating with the UE, according to the second control signal, using the second TCI state during the second time domain window based on the first control signal and an expiration of the first time domain window. The operations of 2025 may be performed in accordance with examples as disclosed herein. In some examples, aspects of the operations of 2025 may be performed by a TCI communications manager 1435 as described with reference to FIG. 14.

The following provides an overview of aspects of the present disclosure:

### Aspect 1

A method for wireless communications at a UE, comprising: receiving a first control signal indicating a first TCI state for a first time domain window and a second TCI state for a second time domain window that is subsequent to the first time domain window, the second TCI state comprising a predicted TCI state; receiving a second control signal triggering activation of the first TCI state for communications during the first time domain window based at least in part on the first control signal; and switching, according to the second control signal, to the second TCI state for communications during the second time domain window based at least in part on the first control signal and an expiration of the first time domain window.

### Aspect 2

The method of aspect 1, wherein receiving the first control signal comprises: receiving an indication of a time offset between a first ending time of the first time domain window and a second ending time of the second time domain window, wherein the expiration of the first time domain window is based at least in part on the time offset.

### Aspect 3

The method of aspect 2, wherein receiving the first control signal comprises: receiving an RRC signal that semi-statically defines the time offset between the first time domain window and the second time domain window.

### Aspect 4

The method of claim 2, wherein receiving the first control signal comprises: receiving DCI that dynamically defines the time offset between the first time domain window and the second time domain window.

### Aspect 5

The method of any of aspects 1 through 4, wherein receiving the first control signal comprises: receiving an indication of a plurality of second time domain windows, wherein the second time domain window is one of the plurality of second time domain windows, where each time domain window in the plurality of second time domain windows is associated with a respective predicted TCI state, wherein a sequentially last time domain window of the plurality of second time domain windows is associated with an undefined ending point.

### Aspect 6

The method of any of aspects 1 through 5, wherein a duration of the second time domain window is based on a duration of the first time domain window in accordance with a defined ratio.

### Aspect 7

The method of any of aspects 1 through 6, wherein the first time domain window and the second time domain window are equal in duration.

### Aspect 8

The method of any of aspects 1 through 7, wherein the first time domain window and the second time domain window are unequal in duration.

### Aspect 9

The method of any of aspects 1 through 8, further comprising: receiving, via the first control signal, one or more TCI state codepoints, each TCI state codepoint identifying a set of predicted TCI states during a corresponding set of second time domain windows, the set of predicted TCI states based at least in part on the second TCI state; and receiving, via the second control signal, a TCI state codepoint from the one or more TCI state codepoints, wherein switching to the second TCI state is based at least in part on receiving the TCI state codepoint.

### Aspect 10

The method of aspect 9, further comprising: receiving, via the first control signal, for each TCI state codepoint in the one or more TCI state codepoints, an indication of a number of predicted TCI states for the TCI state codepoint.

### Aspect 11

The method of any of aspects 9 through 10, wherein each TCI state codepoint in the one or more TCI state codepoints includes a common number of predicted TCI states.

### Aspect 12

The method of any of aspects 9 through 11, further comprising: receiving, via the second control signal, for each TCI state codepoint in the one or more TCI state codepoints, an indication of a duration of a time domain window for each predicted TCI state in the set of predicted TCI states, wherein the second time domain window is based at least in part on the duration.

### Aspect 13

The method of any of aspects 9 through 12, each time domain window of each predicted TCI state in the set of predicted TCI states has an equal duration, wherein the second time domain window comprises the equal duration.

### Aspect 14

The method of any of aspects 1 through 13, further comprising: receiving the first control signal via a group common MAC-CE, wherein the UE belongs to a group of UEs associated with the group common MAC-CE.

### Aspect 15

The method of any of aspects 1 through 14, further comprising: receiving the second control signal via a group common DCI, wherein the UE belongs to a group of UEs associated with the group common DCI.

### Aspect 16

The method of aspect 15, wherein the first control signal indicates that the UE belongs to the group of UEs.

### Aspect 17

The method of any of aspects 1 through 16, further comprising: receiving the second control signal via a UE-specific DCI.

### Aspect 18

The method of any of aspects 1 through 17, further comprising: receiving, prior to the second time domain window, a third control signal triggering activation of an updated TCI state during the second time domain window; and overriding switching to the second TCI state and switching to the updated TCI state during the second time domain window based at least in part on the third control signal.

### Aspect 19

A method for wireless communications at a network entity, comprising: transmitting, to a UE, a first control signal indicating a first TCI state for a first time domain window and a second TCI state for a second time domain window that is subsequent to the first time domain window, the second TCI state comprising a predicted TCI state; transmitting a second control signal to the UE triggering activation of the first TCI state for communications during the first time domain window based at least in part on the first control signal; and communicating with the UE, according to the second control signal, using the second TCI state during the second time domain window based at least in part on the first control signal and an expiration of the first time domain window.

### Aspect 20

The method of aspect 19, wherein transmitting the first control signal comprises: transmitting an indication of a time offset between a first ending time of the first time domain window and a second ending time of the second time domain window, wherein the expiration of the first time domain window is based at least in part on the time offset.

### Aspect 21

The method of aspect 20, wherein transmitting the first control signal comprises: transmitting an RRC signal that semi-statically defines the time offset between the first time domain window and the second time domain window.

### Aspect 22

The method of claim 20, wherein transmitting the first control signal comprises: transmitting DCI that dynamically defines the time offset between the first time domain window and the second time domain window.

### Aspect 23

The method of any of aspects 19 through 22, wherein transmitting the first control signal comprises: transmitting an indication of a plurality of second time domain windows, wherein the second time domain window is one of the plurality of second time domain windows, where each time domain window in the plurality of second time domain windows is associated with a respective predicted TCI state, wherein a sequentially last time domain window of the plurality of second time domain windows is associated with an undefined ending point.

### Aspect 24

The method of any of aspects 19 through 23, wherein a duration of the second time domain window is based on a duration of the first time domain window in accordance with a defined ratio.

### Aspect 25

The method of any of aspects 19 through 24, wherein the first time domain window and the second time domain window are equal in duration.

### Aspect 26

The method of any of aspects 19 through 25, wherein the first time domain window and the second time domain window are unequal in duration.

### Aspect 27

The method of any of aspects 19 through 26, further comprising: transmitting, via the first control signal, one or more TCI state codepoints, each TCI state codepoint identifying a set of predicted TCI states during a corresponding set of second time domain windows, the set of predicted TCI states based at least in part on the second TCI state; and transmitting, via the second control signal, a TCI state codepoint from the one or more TCI state codepoints, wherein communicating with the UE using the second TCI state is based at least in part on transmitting the TCI state codepoint.

### Aspect 28

The method of aspect 27, further comprising: transmitting, via the first control signal, for each TCI state codepoint in the one or more TCI state codepoints, an indication of a number of predicted TCI states for the TCI state codepoint.

### Aspect 29

The method of any of aspects 27 through 28, wherein each TCI state codepoint in the one or more TCI state codepoints includes a common number of predicted TCI states.

### Aspect 30

The method of any of aspects 27 through 29, further comprising: transmitting, via the second control signal, for each TCI state codepoint in the one or more TCI state codepoints, an indication of a duration of a time domain window for each predicted TCI state in the set of predicted TCI states, wherein the second time domain window is based at least in part on the duration.

### Aspect 31

The method of any of aspects 27 through 30, each time domain window of each predicted TCI state in the set of predicted TCI states has an equal duration, wherein the second time domain window comprises the equal duration.

### Aspect 32

The method of any of aspects 19 through 31, further comprising: transmitting the first control signal via a group common MAC-CE, wherein the UE belongs to a group of UEs associated with the group common MAC-CE.

### Aspect 33

The method of any of aspects 19 through 32, further comprising: transmitting the second control signal via a group common DCI, wherein the UE belongs to a group of Ues associated with the group common DCI.

### Aspect 34

The method of aspect 33, wherein the first control signal indicates that the UE belongs to the group of Ues.

### Aspect 35

The method of any of aspects 19 through 34, further comprising: transmitting the second control signal via a UE-specific DCI.

### Aspect 36

The method of any of aspects 19 through 35, further comprising: transmitting, prior to the second time domain window, a third control signal triggering activation of an updated TCI state during the second time domain window; and overriding a switch to the second TCI state and switching to the updated TCI state during the second time domain window based at least in part on the third control signal.

### Aspect 37

An apparatus for wireless communications at a UE, comprising a processor; memory coupled with the processor; and instructions stored in the memory and executable by the processor to cause the apparatus to perform a method of any of aspects 1 through 18.

### Aspect 38

An apparatus for wireless communications at a UE, comprising at least one means for performing a method of any of aspects 1 through 18.

### Aspect 39

A non-transitory computer-readable medium storing code for wireless communications at a UE, the code comprising instructions executable by a processor to perform a method of any of aspects 1 through 18.

### Aspect 40

An apparatus for wireless communications at a network entity, comprising a processor; memory coupled with the processor; and instructions stored in the memory and executable by the processor to cause the apparatus to perform a method of any of aspects 19 through 36.

### Aspect 41

An apparatus for wireless communications at a network entity, comprising at least one means for performing a method of any of aspects 19 through 36.

### Aspect 42

A non-transitory computer-readable medium storing code for wireless communications at a network entity, the code comprising instructions executable by a processor to perform a method of any of aspects 19 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive a first control signal indicating a first transmission configuration indicator (TCI) state for a first time domain window and a second TCI state for a second time domain window that is subsequent to the first time domain window, the second TCI state comprising a predicted TCI state;
receive a second control signal triggering activation of the first TCI state for communications during the first time domain window based at least in part on the first control signal; and
switch, accord to the second control signal, to the second TCI state for communications during the second time domain window based at least in part on the first control signal and an expiration of the first time domain window.

2. The apparatus of claim 1, wherein the instructions to receive the first control signal are executable by the processor to cause the apparatus to:
receive an indication of a time offset between a first ending time of the first time domain window and a second ending time of the second time domain window, wherein the expiration of the first time domain window is based at least in part on the time offset.

3. The apparatus of claim 2, wherein the instructions to receive the first control signal are executable by the processor to cause the apparatus to:
receive a radio resource control (RRC) signal that semi-statically defines the time offset between the first time domain window and the second time domain window.

4. The apparatus of claim 2, wherein the instructions to receive the first control signal are executable by the processor to cause the apparatus to:
receive downlink control information that dynamically defines the time offset between the first time domain window and the second time domain window.

5. The apparatus of claim 1, wherein the instructions to receive the first control signal are executable by the processor to cause the apparatus to:
receive an indication of a plurality of second time domain windows, wherein the second time domain window is one of the plurality of second time domain windows, where each second time domain window in the plurality of second time domain windows is associated with a respective predicted TCI state, wherein a sequentially last time domain window of the plurality of second time domain windows is associated with an undefined ending point.

6. The apparatus of claim 1, wherein a duration of the second time domain window is based on a duration of the first time domain window in accordance with a defined ratio.

7. The apparatus of claim 1, wherein the first time domain window and the second time domain window are equal in duration.

8. The apparatus of claim 1, wherein the first time domain window and the second time domain window are unequal in duration.

9. The apparatus of claim 1, wherein the instructions are further executable by the processor to cause the apparatus to:
receive, via the first control signal, one or more TCI state codepoints, each TCI state codepoint identifying a set of predicted TCI states during a corresponding set of second time domain windows, the set of predicted TCI states based at least in part on the second TCI state; and
receive, via the second control signal, a TCI state codepoint from the one or more TCI state codepoints, wherein switching to the second TCI state is based at least in part on receiving the TCI state codepoint.

10. The apparatus of claim 9, wherein the instructions are further executable by the processor to cause the apparatus to:
receive, via the first control signal, for each TCI state codepoint in the one or more TCI state codepoints, an indication of a number of predicted TCI states for the TCI state codepoint.

11. The apparatus of claim 9, wherein each TCI state codepoint in the one or more TCI state codepoints includes a common number of predicted TCI states.

12. The apparatus of claim 9, wherein the instructions are further executable by the processor to cause the apparatus to:
receive, via the second control signal, for each TCI state codepoint in the one or more TCI state codepoints, an indication of a duration of a time domain window for each predicted TCI state in the set of predicted TCI states, wherein the second time domain window is based at least in part on the duration.

13. The apparatus of claim 9, wherein the second time domain window comprises an equal duration.

14. The apparatus of claim 1, wherein the instructions are further executable by the processor to cause the apparatus to:
receive the first control signal via a group common medium access control-control element (MAC-CE), wherein the UE belongs to a group of Ues associated with the group common MAC-CE.

15. The apparatus of claim 1, wherein the instructions are further executable by the processor to cause the apparatus to:
receive the second control signal via a group common downlink control information (DCI), wherein the UE belongs to a group of Ues associated with the group common DCI.

16. The apparatus of claim 15, wherein the first control signal indicates that the UE belongs to the group of Ues.

17. The apparatus of claim 1, wherein the instructions are further executable by the processor to cause the apparatus to:
receive the second control signal via a UE-specific downlink control information (DCI).

18. The apparatus of claim 1, wherein the instructions are further executable by the processor to cause the apparatus to:
receive, prior to the second time domain window, a third control signal triggering activation of an updated TCI state during the second time domain window; and
override switching to the second TCI state and switching to the updated TCI state during the second time domain window based at least in part on the third control signal.

19. An apparatus for wireless communications at a network entity, comprising:
a processor;
memory coupled with the processor; and
instructions stored in the memory and executable by the processor to cause the apparatus to:
transmit, to a user equipment (UE), a first control signal indicating a first transmission configuration indicator (TCI) state for a first time domain window and a second TCI state for a second time domain window that is subsequent to the first time domain window, the second TCI state comprising a predicted TCI state;
transmit a second control signal to the UE triggering activation of the first TCI state for communications during the first time domain window based at least in part on the first control signal; and
communicate with the UE, according to the second control signal, using the second TCI state during the second time domain window based at least in part on the first control signal and an expiration of the first time domain window.

20-28. (canceled)

29. A method for wireless communications at a user equipment (UE), comprising:
receiving a first control signal indicating a first transmission configuration indicator (TCI) state for a first time domain window and a second TCI state for a second time domain window that is subsequent to the first time domain window, the second TCI state comprising a predicted TCI state;
receiving a second control signal triggering activation of the first TCI state for communications during the first time domain window based at least in part on the first control signal; and
switching, according to the second control signal, to the second TCI state for communications during the second time domain window based at least in part on the first control signal and an expiration of the first time domain window.

30. (canceled)
